(19) United States
(12) Patent Application Publication
(10) Pub. No.: US 2014/0169330 A1
(43) Pub. Date: Jun. 19, 2014

(54) Network Gateway Selection at Multipath Communication

(71) Applicant: Telefonaktiebolaget L M Ericsson (publ), (US)

(72) Inventors: Stefan ROMMER, Vastra Frolunda (SE); Dinand Roeland, Sollentuna (SE); Yong Yang, Molndal (SE); Goran Hall, Molndal (SE)

(73) Assignee: Telefonaktiebolaget L M Ericsson (publ), Stockholm (SE)

(21) Appl. No.: 13/715,633

(22) Filed: Dec. 14, 2012

Related U.S. Application Data
(63) Continuation of application No. PCT/EP2012/075538, filed on Dec. 14, 2012.

(51) Int. Cl. H04W 36/08

(52) U.S. Cl. CPC H04W 36/08
USPC 370/331

(57) ABSTRACT

This disclosure relates to a method in a source network gateway node (110b) and a source network gateway node configured to operatively perform said method which redirects a communication path (182; 184) between a peer node (190) and a radio terminal (180) supporting multipath communication with the peer node (190) so as to enable a plurality of communication paths (182, 184) between the radio terminal (180) and the peer node (190). The method comprises the actions of: receiving (A1) an establishing message from a signaling node arrangement (120a, 120b, 130, 150) signaling the establishment of a new communication path (182; 184) between the radio terminal (180) and the peer node (190) via the source network gateway node (110b), determining (A2) whether there already is an existing communication path (184; 182) between the radio terminal (180) and the peer node (190) via a target network gateway node (110a), initiating a redirect (A3a) of the new communication path (182; 184) if there is an existing communication path (184; 182) such that the new communication path (182; 184) is established via the target network gateway node (110a).

### TECHNICAL FIELD

Exemplifying embodiments presented herein are directed to a source network gateway node and a method therein for selecting a target network gateway in connection with multipath transmissions between end devices connected via one or more wireless communication network.

### BACKGROUND

In a wireless communications network wireless radio terminals communicate via one or more Radio Access Networks (RAN) each associated with one or more core networks.

The radio terminal may e.g. be a mobile station (MS) or a user equipment unit (UE) or similar, e.g. such as a mobile telephone also known as “cellular” telephone, or laptops or a similar device with wireless capability. The radio terminal may e.g. be a portable, pocket, hand-held, computer-comprised device. The radio terminal may e.g. be a device that is mobile, portable, semi-stationary, or stationary. The radio terminal may be a device mounted in vehicles, kitchen appliances or consumer electronics or similar. The radio terminal is configured to operatively communicate voice and/or data with the radio access network.

The Radio Access Network (RAN) may cover a geographical area, which may be divided into cell areas. Each such cell area is served by a radio access node, e.g. a Radio Base Station (RBS) a “NodeB” or “B node” or enhanced NodeB (eNB) or similar providing wireless access for the radio terminals to the core network of the wireless communication network. A cell area is a geographical area wherein radio coverage is provided by the equipment of a radio access node. Each cell may be identified by an identity, which may be broadcasted in the cell. The radio access nodes communicate via an air interface with the radio terminals within range of the radio access node.

In some versions of the radio access network, several base stations are typically connected, e.g. by landlines or microwave links, to a Radio Network Controller (RNC). The radio network controller, also sometimes termed a Base Station Controller (BSC), supervises and coordinates various activities of the plural base stations connected thereto. The radio network controllers are typically connected to one or more core networks

For example, the General Packet Radio Service (GPRS) is a wireless communication system, which evolved from the GSM. The GSM EDGE Radio Access Network (GERAN) is a radio access network for enabling radio terminals to communicate with one or more core networks. Similarly, the Universal Mobile Telecommunications System (UMTS) is a third generation wireless communication system, which evolved from the Global System for Mobile Communications (GSM). The UMTS Terrestrial Radio Access Network (UTRAN) or Evolved UMTS Terrestrial Radio Access Network (E-UTRAN) can be seen as a radio access network typically using wideband code division multiple access for enabling radio terminals to communicate with one or more core networks.

The core network of a wireless communication network may e.g. comprise one or more core network nodes and/or core network functions, e.g. such as a Mobility Management Entity (MME) and/or a Serving Gateway (SGW) and/or a PDN Gateway (PGW) and/or a Serving GPRS Support Node (SGSN) and/or a Gateway GPRS Support Node (GGSN) and/or an Authentication, Authorization and Accounting (AAA) function and/or node and/or a Home Subscriber Server (HSS) and/or a Remote Authentication Dial In User Service (RADIUS) or similar.

The properties and functions of radio terminals, radio access networks and core networks nodes of a wireless communication network as mentioned above are well known to those skilled in the art and they need no detailed description as such. Nevertheless, the properties and functions of some such features will be elaborated in some detail later when discussing embodiments of the present solution with reference to FIGS. 3, 4a, 4b and 4c.

Communication schemes established in wireless communication networks of the type indicated above are typically restricted to a single path per connection. The standard TCP/IP is an example of such a single path communication scheme. A “path” may e.g. be defined as: A sequence of links between a sender and a receiver, defined in this context by a source and destination address pair.

However, there are known mechanisms that allow multipath per connections. For example, the Internet Engineering Task Force (IETF) is currently working on mechanisms that add the capability of simultaneously using multiple paths to a regular TCP session. The extensions to TCP, called Multi-Path TCP (MPTCP) are e.g. described in the Internet-Draft “draft-ietf-mptcp-multiaddressed”. Architectural guidelines for multipath TCP development have e.g. been published in the IETF specification RFC 6182.

Today there are a number of cases where multiple paths exist between peers, e.g. in case at least one of two end-devices is multi-homed and/or has connectivity via more than one access technology. For example, in a Third Generation Partnership Project (3GPP) multi-access scenario a radio terminal (e.g. an UE) may be connected via both a 3GPP access (such as GERAN, UTRAN, E-UTRAN or similar) and WLAN access simultaneously. The simultaneous use of such multiple paths for a TCP/IP session would improve resource usage within the network and improve the user experience through higher throughput and improved resilience to network failure. The use of MPTCP over multiple accesses would allow the user traffic to be either routed only over one of the available accesses or simultaneously over multiple accesses. It would also allow the traffic to be moved in a seamless fashion between accesses depending on coverage, radio link quality and other factors.

MPTCP as defined by IETF can be used end-to-end between a radio terminal such as an UE and a peer (e.g. a server or similar on Internet or similar or another radio terminal or similar). However, this would require MPTCP support in both the radio terminal and its peer. In addition, the use of end-to-end multi-path communication such as end-to-end MPTCP would typically cause problems in the core networks. For example, it may be difficult or impossible to perform policy enforcement and Deep Packet Inspection (DPI) etc when various TCP/IP flows for a single application session may traverse multiple network gateways such as one or more GGSN:s and/or PGW:s, since such enforcements and/or inspections etc are normally done in a single network gateway node, which e.g. may comprise a Policy and Charging Enforcement Function (PCEF) or similar.

To overcome this problem and also to remove the need for MPTCP support in the peer it is beneficial to implement an MPTCP Proxy in the PGW or similar. In this way it is possible to handle all TCP/IP flows for an application in a single network gateway thus enabling policy enforcement and DPI per existing standards and deployments. The MPTCP Proxy would appear to the peer as a legacy TCP host without MPTCP functionality. The MPTCP Proxy would thus enable multipath benefits for the radio terminal without requiring MPTCP support at the peer.

FIG. 1 is a schematic illustration of an exemplifying architecture with a MPTCP proxy implemented in a network gateway in the form of a PGW. An UE configured to support MPTCP has established multi path communication via the MPTCP proxy with a peer that has no support for MPTCP. More precisely it is assumed that the UE has established communication with the MPTCP proxy via a first path supported by a 3GPP access, e.g. utilizing a GERAN, UTRAN or an E-UTRAN, and via a second path supported by a Wireless Local Area Network (WLAN) access. The first path has been illustrated with a solid line passing from the UE via the 3GPP access to the MPTCP proxy, and the second path has been illustrated by a dashed line passing from the UE via the WLAN access to the MPTCP proxy. The MPTCP Proxy appears to the peer as a legacy TCP host without MPTCP functionality, i.e. there is only one communication path between the MPTCP proxy and the peer. It follows that no MPTCP support is needed in the peer. However, the benefits of multipath communication can still be utilized for the paths between the UE and the MPTCP proxy.

In architectures with MPTCP Proxy implemented in a PGW it is typically assumed that all PDN Connections established with MPTCTP are handled by the same PGW. However, current 3GPP mechanisms do not ensure that the same PGW is selected for different PDN Connections. Instead, when an UE makes an initial attach in one particular access network, that access network may select any PGW supporting the given Access Point Name (APN). As a result the UE may end up with PDN Connections handled by different PGWs, even if the same APN is used in two different access types. This is a problem for the MPTCP Proxy architecture where different PDN Connections need to be coordinated in a single PGW.

FIG. 2 is a schematic illustration of an exemplifying architecture with multiple PDN connections handled by separate PGWs. An UE configured to support MPTCP has established communication with a peer via a first PGW and via a second PGW. It is assumed that the UE is connected to the first PGW via a first path supported by a 3GPP access and to the second PGW via a second path supported by a WLAN access. The first path has been illustrated with a solid line passing from the UE via the 3GPP access to the first PGW and then to the peer. The second path has been illustrated by a dashed line passing from the UE via the WLAN access to the second PGW and then to the peer.

As already mentioned above, such functions as charging, policy enforcement and Deep Packet Inspection (DPI) etc are typically performed for a particular UE in a single network gateway, e.g. a PGW or similar, comprising a Policy and Charging Enforcement Function (PCEF) or similar. Thus, when a UE communicates with a peer via two different PGWs or similar as indicated in FIG. 2 it may be difficult or impossible to perform such functions as charging, policy enforcement and Deep Packet Inspection (DPI) etc for the UE.

It can also be noted that the MPTCP proxy solution described above with reference to FIG. 1 is less useful when a UE establishes communication with a peer via two different PGWs or similar, bearing in mind that the MPTCP proxy is typically comprised by only one of the two PGWs. Two IP address from two (2) different PGWs will therefore be visible to the peer, not the single IP address from a single MPTCP Proxy appearing as a legacy TCP host without MPTCP functionality as described above with reference to FIG. 1. Thus, here it is required that the peer supports MPTCP functionality in case a radio terminal establishes communication with the peer via two different network gateways.

### SUMMARY

In view of the above there seems to be a need for an improved handling of the establishment of communication paths for a radio terminal when multipath communication is used for communicating with a peer of the radio terminal.

At least some of the drawback indicated above are mitigated or eliminated by an embodiment of the present solution directed to a method in a source network gateway node. The method redirects a communication path between a peer node and a radio terminal, which supports multipath communication with the peer node so as to enable a plurality of communication paths between the radio terminal and the peer node. The method comprises the actions of: receiving an establishing message from a signaling node arrangement signaling the establishment of a new communication path between the radio terminal and the peer node via the source network gateway node; determining whether there already is an existing communication path between the radio terminal and the peer node via a target network gateway node; initiating a redirect of the new communication path if there is an existing communication path such that the new communication path is established via the target network gateway node.

Some of the drawback indicated above are also mitigated or eliminated by an embodiment of the present solution directed to a source network gateway node configured to operatively redirect a communication path between a peer node and a radio terminal that supports multipath communication with the peer node so as to enable a plurality of communication paths between the radio terminal and the peer node. The source gateway node comprises: an interfacing arrangement configured to operatively receive an establishing message from a signaling node arrangement signaling the establishment of a new communication path between the radio terminal and the peer node via the source network gateway node; and a processing arrangement configured to operatively determine whether there already is an existing communication path between the radio terminal and the peer node via a target network gateway node, and to operatively initiate a redirect of the new communication path if there is an existing communication path such that the new communication path is established via the target network gateway node.

The embodiments described herein are not limited to the features and advantages indicated above. A person skilled in the art will recognize additional features and advantages upon reading the following detailed description.

### BRIEF DESCRIPTION OF THE DRAWINGS

Exemplifying embodiments of the present solution will be apparent from the following more particular description, as illustrated in the accompanying drawings in which like reference characters refer to the same parts throughout the different views.

FIG. 1 is a schematic illustration of a known architecture with a MPTCP proxy implemented in a network gateway in the form of a PGW,

FIG. 2 is a schematic illustration of a known architecture with multiple PDN connections handled by separate PGWs.;

FIG. 3 is a schematic illustration of an exemplifying wireless communication network 100 according to the 3GPP specifications, wherein embodiments of the present solution can be implemented,

FIG. 4a is a schematic illustration of a Trusted WLAN Access Network (TWAN) according to some embodiments described herein.

FIG. 4b is a schematic illustration of a source network gateway according to some embodiments described herein.

FIG. 4c showing a part of the wireless communication network 100 in FIG. 3 with addition of a separate storing function 410,

FIG. 5 is a schematic illustration of an exemplifying flowchart showing operations of some exemplifying embodiments described herein,

FIG. 6a is a schematic illustration of an exemplifying signaling diagram showing actions of an exemplifying embodiment described herein,

FIG. 6b is a schematic illustration of an exemplifying signaling diagram showing actions of another exemplifying embodiment described herein,

FIG. 6c is a schematic illustration of an exemplifying signaling diagram showing actions of another exemplifying embodiment described herein.

FIG. 6d is a schematic illustration of an exemplifying signaling diagram showing actions of another exemplifying embodiment described herein.

FIG. 6e is a schematic illustration of an exemplifying signaling diagram showing actions of another exemplifying embodiment described herein.

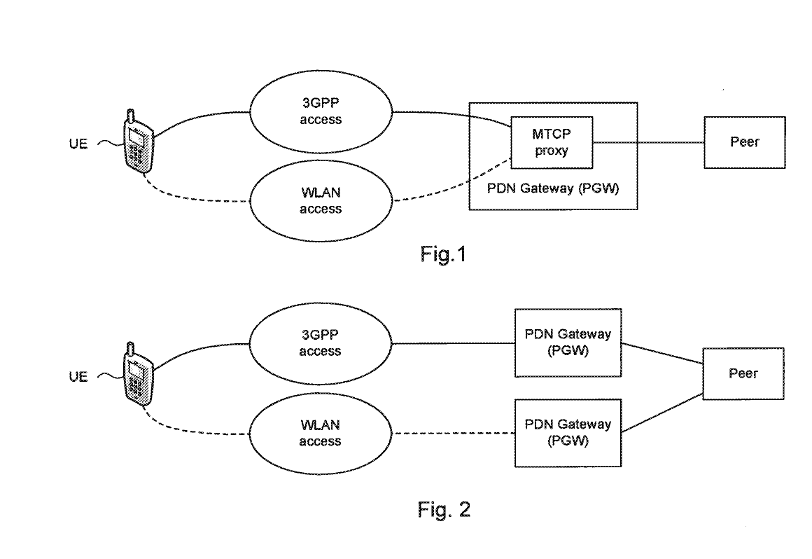

### DETAILED DESCRIPTION

In the following description, for purposes of explanation and not limitation, specific details are set forth in order to provide a thorough understanding of the exemplifying embodiments. However, it will be apparent to one skilled in the art that the exemplifying embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

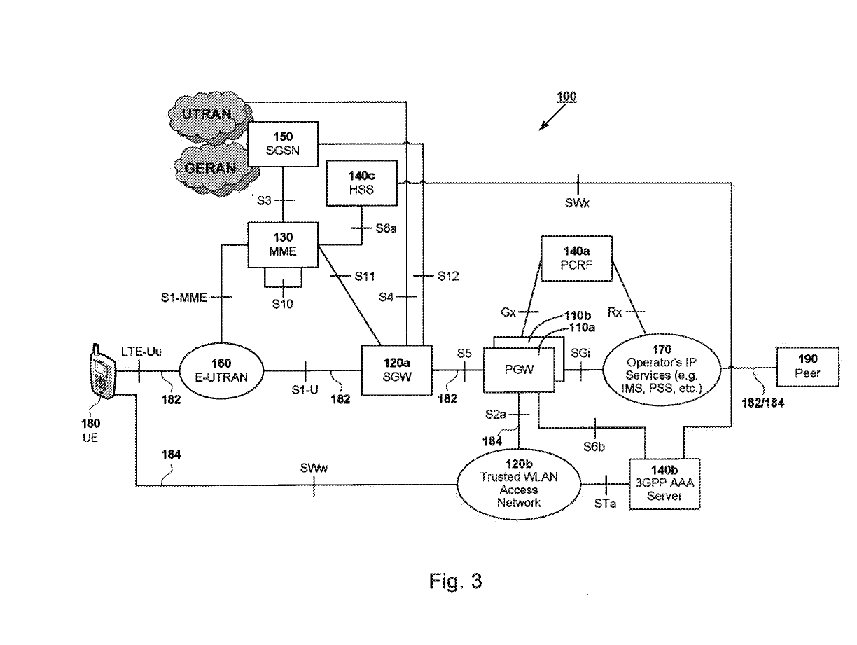

FIG. 3 is a schematic illustration of an exemplifying wireless communication network 100 wherein embodiments of the present solution can be implemented. The system is a so called LTE based system according to the 3GPP specifications. It should be pointed out that the terms “LTE” and “LTE based” system is here used to comprise both present and future LTE based systems, such as, for example, advanced LTE systems.

It should be appreciated that although FIG. 3 shows a wireless communication system in the form of a LTE based system, the example embodiments herein may also be utilized in connection with other wireless communication systems comprising nodes and functions that correspond to the nodes and functions of system in FIG. 3.

The exemplifying system 100 comprises at least one User Equipment (UE) 180 and an E-UTRAN 160 (preferably comprising one or more eNodeBs, not shown in FIG. 3) that is connected to a Serving Gateway (SGW) 120a and to a Mobility Management Entity (MME) 130. The SGW 120a is connected to the MME 130 and to one or both of the PDN Gateways (PGW) 110a, 110b. In addition, the SGW 120a may be connected to a SGSN 150 and preferably also to the UTRAN 160. The MME 130 may be additionally connected to a Home Subscriber Server (HSS) 140 and preferably also to the SGSN 150. Each PGW 110a, 110b may be connected to a Policy and Charging Rules Function (PCRF) 140a and to an Operator's IP Service 170, which e.g. may be the Internet or an Intranet or similar. Each PGW 110a, 110b may be connected to a Trusted WLAN Access Network (TWAN) 120b. Each PGW 110a, 110b may be connected to a 3GPP AAA server 140b.

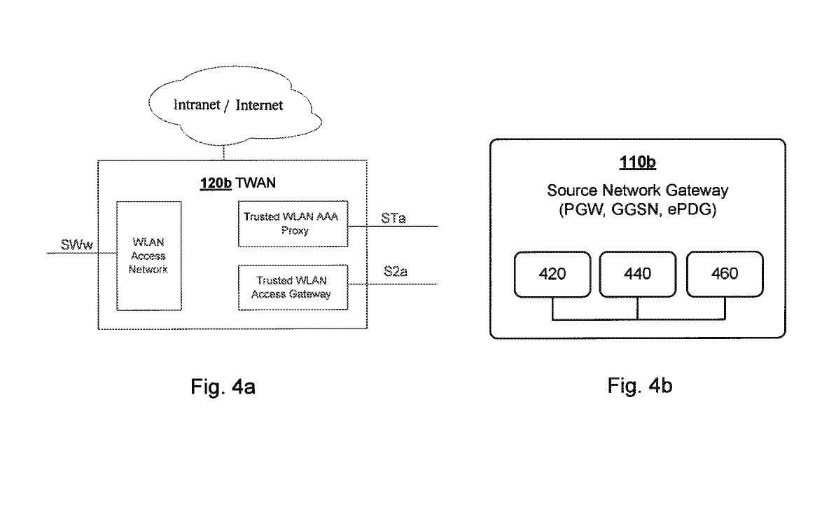

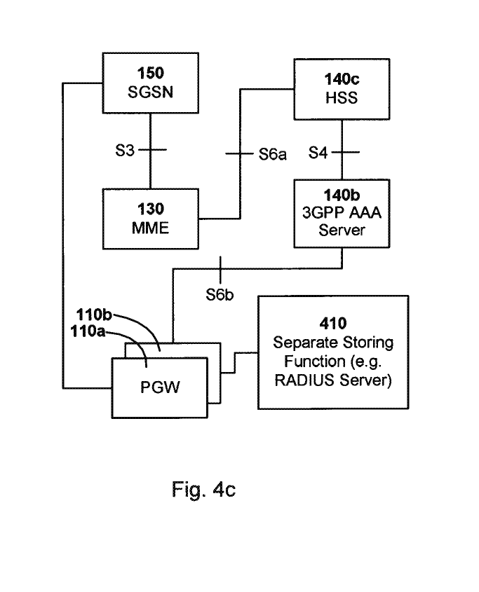

The basic properties and functions of the entities in the exemplifying system 100 are well known to those skilled in the art. Nevertheless, some basic properties and functions of such entities and also properties and functions of embodiments of the present solution will be elaborated below with reference to FIG. 3 and also with reference to FIGS. 4a, 4b and 4c.

The User Equipment (UE) 180 is an example of a radio terminal or similar, e.g. such as a mobile telephone also known as “cellular” telephone, or a laptop with wireless capability. The radio terminal may e.g. be a portable, pocket, hand-held, computer-comprised device. The radio terminal may e.g. be a mobile, portable or stationary device. The radio terminal may be embedded (e.g. as a card or a circuit arrangement or similar) in and/or attached to various other devices, e.g. such as various laptop computers or tablets or similar or other consumer electronics or similar, or vehicles or boats or air planes or other movable devices, e.g. intended for transport purposes. Indeed, the radio terminal may even be embedded in and/or attached to various semi-stationary devices, e.g. domestic appliances such as kitchen appliances like refrigerators or thermometers or similar, or consumer electronics such as printers or similar or hospital equipment such as various machines connected to a human patient e.g. having a semi-stationary mobility character.

The Peer 190 may be any other terminal, device or node or similar that is configured to operatively communicate with the UE 180 or similar radio terminal. Indeed, the peer 190 may e.g. be another UE or similar, or the peer may be a server connected to an external network, where the network gateway nodes mentioned herein acts as an interface between the system 100 and an such external networks. One external network may e.g. be the Operator's IP Services 170 and/or the TWAN 120b shown in FIG. 3.

The eNodeB (eNB) (not shown in FIG. 3) is an example of a radio access node that interfaces with radio terminals such as the UE 180 and/or similar. In fact, the eNodeBs of the system forms the radio access network E-UTRAN 160 for LTE.

The Serving Gateway (SGW) 120a is an example of a core network node that routes and forwards user data packets for radio terminals between the radio access network (e.g. E-UTRAN 160) and the core network of a wireless communication network (e.g. the Evolved Packet Core (EPC)). The SGW 120a may also act as the mobility anchor for the user plane during inter-eNB handovers and as the anchor for mobility between LTE and other 3GPP technologies (terminating 54 interface and relaying the traffic between 2G/3G systems and PDN GW). For idle state UEs, the SGW 120a terminates the DL data path and triggers paging when DL data arrives for the UE 180. It manages and stores UE contexts, e.g. parameters of the IP bearer service, network internal routing information. It also performs replication of the user traffic in case of lawful interception.

The Mobility Management Entity (MME) 130 is an example of a core network node that controls the handover of radio terminals such as the UE 180. Other such nodes may e.g. be a Base Station Controller (BSC) or a Radio Network Controller (RNC) or similar. The MME 130 is the key control-node for the LTE access-network. It is responsible for idle mode UE tracking and paging procedure including retransmissions. It is involved in the bearer activation/deactivation process and is also responsible for choosing the SGW 120a for a UE 180 at the initial attach and at time of intra-LTE handover involving Core Network (CN) node relocation. It is responsible for authenticating the user (by interacting with the HSS 140c e.g. via the S6a interface). The Non-Access Stratum (NAS) signaling terminates at the MME 130 and it is also responsible for generation and allocation of temporary identities to UEs. It checks the authorization of the UE 180 to camp on the service provider's Public Land Mobile Network (PLMN) and enforces UE roaming restrictions. The MME 130 is the termination point in the network for ciphering/integrity protection for NAS signaling and handles the security key management. Lawful interception of signaling is also supported by the MME 130. The MME 130 also provides the control plane function for mobility between LTE and 2G/3G access networks with the S3 interface terminating at the MME 130 from the SGSN 150. The MME 130 also terminates the S6a interface towards the home HSS 140c for roaming UEs

The PDN Gateway (PGW) nodes 100a, 11013 are examples of core network gateway nodes that provide connectivity for the UE 180 and similar radio terminals to external networks such as packet data networks, preferably by being the point of exit and entry of traffic for the UE 180 and similar radio terminals. In other words, a gateway node acts as an interface between the wireless communication system 100 and external networks, e.g. such as the Operator's IP Services 170 and/or the TWAN 120b shown in FIG. 3.

As already indicated, the exemplifying system 100 in FIG. 3 comprises a first PGW 110a and a second PGW 110b. The first PGW 110a may be connected to the PCRF 140a (e.g. via the Gx interface), to the Operator's IP Service 170 (e.g. via the SGi interface), to the TWAN 120b (e.g. via the S2a interface) and/or to a 3GPP AAA server 140b (e.g. via the S6b interface). Similarly, the second PGW 110b may be connected to the PCRF 140a (e.g. via the Gx interface), to the Operator's IP Service 170 (e.g. via the SGi interface), to the TWAN 120b (e.g. via the S2a interface) and/or to a 3GPP AAA server 140b (e.g. via the 56b interface).

A radio terminal configured to support multipath connections (e.g. the UE 180 or similar) may have simultaneous connectivity with more than one network gateway node (e.g. PGWs 110a, 110b or similar), e.g. for accessing multiple PDNs. An example of a known simultaneous connectivity can be found in the multipath scenario discussed above with reference to FIG. 2. Details of this known scenario can e.g. be elaborated with reference to system 100 in FIG. 3.

Thus, in the same manner as in the multipath scenario in FIG. 2 it may be assumed that the UE 180 in FIG. 3 is configured to support multipath communication, e.g. MPTCP or similar. It may also be assumed that the UE 180 has established communication with the peer 190 both via the first PGW 110a and the second PGW 110b. For example, it may be assumed that the UE 180 is connected to the peer 190 via a first communication path 182 supported by a 3GPP access. The a first communication path may e.g. extend from the UE 180 to the peer 190 via the E-UTRAN 160, the SGW 120a, the PGW 110a and the Operator's IP Services 170. Similarly, it may be assumed that the UE 180 is connected to the peer 190 via a second communication path 184 supported by a WLAN access. The second communication path may e.g. extend from the UE 180 to the peer 190 via the TWAN 120b, the second PGW 110b, and the Operator's IP Services 170. Thus, the first communication path may e.g. be set up via the interfaces LTE-Uu, S1-U, S5 and the SGi such that the peer 190 has connection with the first PGW 110a via the SGi interface, and that the second communication path may e.g. be set up via the interfaces SWw, S2a and the SGi such that the peer 190 has connection with the second PGW 110b via the SGi interface. However, as discussed above with reference to FIG. 2, this known multipath setup has several drawbacks, which is eliminated or at least mitigated by embodiments discussed herein.

Before proceeding it should be added that a PGW may perform policy enforcement, packet filtering, charging support, lawful Interception and packet screening etc. This may e.g. be done for each radio terminal or similar served by the PGW in question and/or for each application or similar used by such a radio terminal or similar. Another key role of a PGW is to act as the anchor for mobility between 3GPP and non-3GPP technologies such as WiMAX and 3GPP2 (CDMA 1X and EvDO).

Before proceeding it should also be added that it is preferred that at the source network gateway and the target network gateway and at least the at least the target network gateway (e.g. such as the PGW 110a or similar discussed below) is configured to operatively act as a Policy and Charging Enforcement Function (PCEF), e.g. performing at least one of: policy enforcement, packet filtering, charging support, lawful Interception or packet screening as indicated above.

The Policy and Charging Rules Function (PCRF) 140a determines policy rules in real-time with respect to the radio terminals of the system. This may e.g. include aggregating information in real-time to and from the core network and/or operational support systems etc of the system 100 so as to support the creation of rules and/or automatically making policy decisions for user radio terminals currently active in the system 100 based on such rules or similar. The PCRF 140a provides the PGW acting as a Policy and Charging Enforcement Function (PCEF) with such rules and/or policies or similar to be used by the PGW acting as a PCEF.

The Serving GPRS Support Node (SGSN) 150 is another example of a core network node that routes and forwards user data packets for radio terminals between the radio access network (e.g. UTRAN and/or GERAN) and the core network of a wireless communication network. The SGSN 150 is responsible for the delivery of data packets from and to the radio terminals such as mobile stations within its geographical service area. Its tasks may include packet routing and transfer, mobility management (attach/detach and location management), and logical link management etc. A location register of the SGSN 150 may store location information (e.g., current cell, current Visitor Location Register (VLR)) and user profiles (e.g., International Mobile Station Identity (IMSI), address(es) used in the packet data network) of all GPRS users registered with this SGSN 150.

The Home Subscriber Server (HSS) 140c is a user database that may contain subscription-related information (subscriber profiles), may perform authentication and authorization of a subscriber, and may provide information about the subscriber's location and IP information. The HSS 140c is similar to the GSM Home Location Register (HLR). As indicated in FIG. 3 the HSS 140c may be connected to the MME 130 (S6a) and to the 3GPP AAA server 140b (SWx).

The 3GPP AAA server 140b can be seen as a server program that handles user requests for access resources provided by and/or accessible via the wireless communication network and, may provide authentication, authorization, and accounting (AAA) services. The AAA server typically interacts with network access and gateway servers and with databases and directories containing user information, as indicated in FIG. 3 by the connection of the 3GPP AAA server 140b to the TWAN 120b (STa), to the source PGW (S6B) and to the HSS 140c (SWx). The current standard by which devices or applications communicate with an AAA server is the Remote Authentication Dial-In User Service (RADIUS). Thus, the 3GPP AAA server 140b may also be denoted a RADUIS server or function.

FIG. 4a shows some details of the Trusted WLAN Access Network (TWAN) 120b by providing a schematic illustration of an exemplifying TWAN 120b according to some embodiments described herein. Various detailed functional splits within the TWAN 120b are well known to those skilled in the art and they need no detailed description as such. However, embodiments described herein may assume one or several of the following functions in the TWAN 120b:

(i) A WLAN Access Network (WLAN AN). The WLAN AN includes a collection of one or more WLAN access points. An access point terminates the UE's WLAN IEEE 802.11 link defined in IEEE Std 802.11-2007.

(ii) A Trusted WLAN Access Gateway (TWAG). This function terminates S2a. It also acts as the default router for the UE 180 on its access link, and as a DHCP server for the UE 180. When the TWAN 120b provides access to the core network of the wireless communication network 100 for an UE 180, it forwards packets between the UE-TWAG point-to-point link and the S2a tunnel for that UE 180. The association in the TWAN 120b between UE-TWAG point-to-point link and S2a tunnel is based on the UE MAC address.

(iii) A Trusted WLAN AAA Proxy (TWAP). This function terminates STa. It relays the AAA iFacnformation between the WLAN Access Network and the 3GPP AAA Server 140b or Proxy in case of roaming. It establishes the binding of UE subscription data (including IMSI) with UE MAC address on the WLAN Access Network. If L2 attach triggers are used, it informs the TWAG of L2 attach events. It is aware of UE L2 Detach from the WLAN Access Network and informs the TWAG of L2 Detach events. It provides the TWAG with UE subscription data during initial attach or at UE subscription data modification.

A per-UE point-to-point link between the UE 180 and the TWAG is required when traffic for that UE 180 is routed via S2a. In particular, it is assumed that the WLAN AN enforces upstream and downstream forced-forwarding between the UE's WLAN IEEE 802.11 association and the TWAG. The aspects of point-to-point link described in RFC 5213 and RFC 5844 also apply to the point-to-point link between UE and TWAG. The implementation of the point-to-point link, including how and when it is setup, is out-of-scope of this description.

It may be added that from the UE's perspective the SWw reference point appears as a shared medium/link as any other IEEE 802.11 WLAN and thus the UE 180 can use the subnet prefix/mask and the default GW address for its packet routing decisions. The point-to-point nature of the link is realized by the TWAN 120b enforcing that packets sent from, and received by the UE 180 are respectively forwarded to, and forwarded by the TWAG.

FIG. 4b illustrates an exemplifying source network gateway configuration to operatively perform the actions or similar of the exemplifying embodiments described herein. As indicated above when discussing the first and second PGW 110a, 110b with reference to FIG. 3 both the first PGW 110a and the second PGW 110b may be seen as network gateways. Other network gateways may e.g. be a Gateway GPRS Support Node (GGSN) or an Evolved Packet Data Gateway (ePDG) or similar. Here, it may be clarified that the S2a interface discussed above with reference to FIG. 4b correspond to an S2b interface that is also defined in the 3GPP specifications. However, the S2a interface connects a PGW and a TWAG as shown in FIG. 4a whereas the S2b interface connects a PGW and an ePDG. As shown in FIG. 4b, the source network gateway may comprise processing arrangement 420, a memory arrangement 440 and an interfacing arrangement 460. In particular embodiments, some or all of the actions or similar described herein may be provided by the processing arrangement 420 executing instructions stored in the memory arrangement 440 and communicating with other nodes or similar via the interfacing arrangement 460. Alternative embodiments of the source network gateway may comprise additional components responsible for providing additional functionality, comprising any of the functionality identified herein and/or any functionality necessary to support the example embodiments described herein. The processing arrangement 420, the memory arrangement 440 and the interfacing arrangement 460 may be implemented in hardware or software or a combination of hardware and software. The hardware may e.g. be implemented by one or more electronic circuits or similar of the type commonly used in network gateways of the kind now discussed. The software may e.g. be implemented as one or more sets of programming code of the type commonly used in network gateways of the kind now discussed.

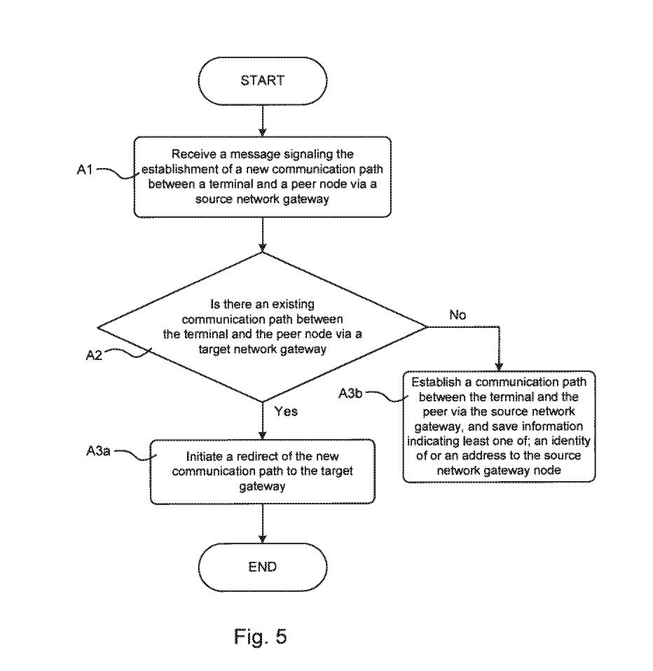

FIG. 5 illustrates a flow diagram depicting a number of exemplifying actions A1, A2, A3a, A3b which may be taken by a source network gateway in connection with performing a method for redirecting a new communication path between a radio terminal and a peer node, where the radio terminal supports multipath communication with the peer node, enabling a plurality of communication paths between the radio terminal and the peer node to pass through one common network gateway node.

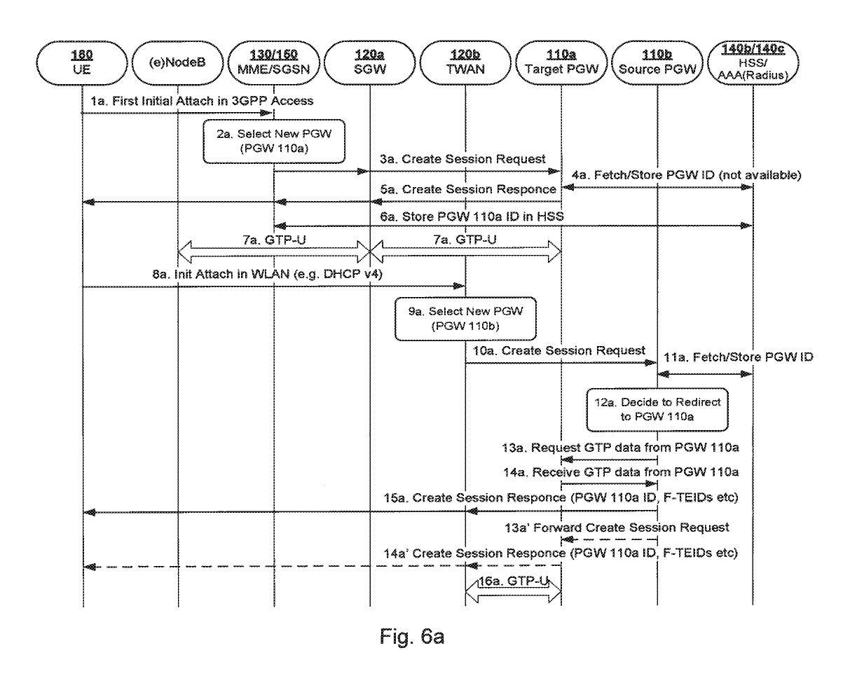

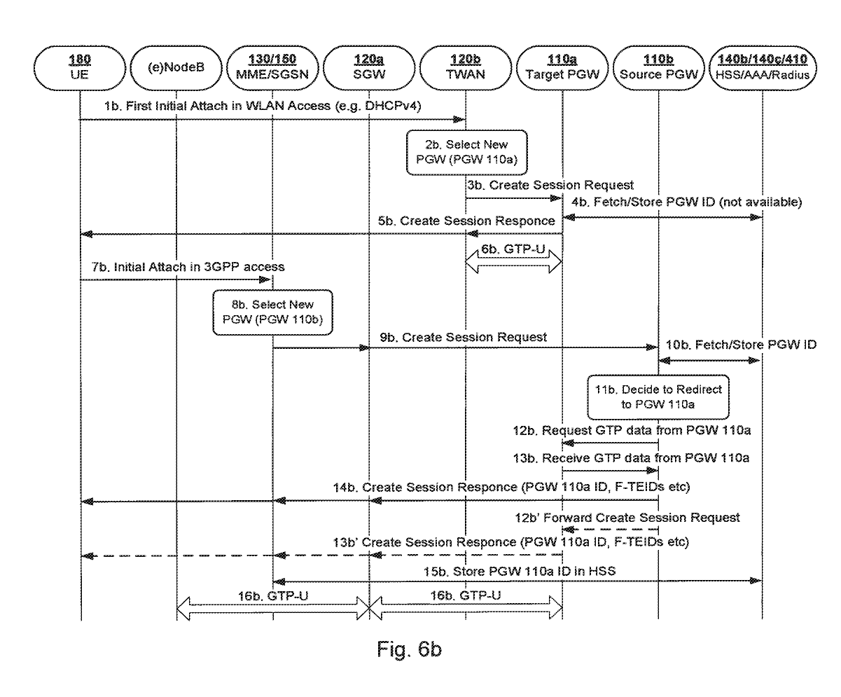

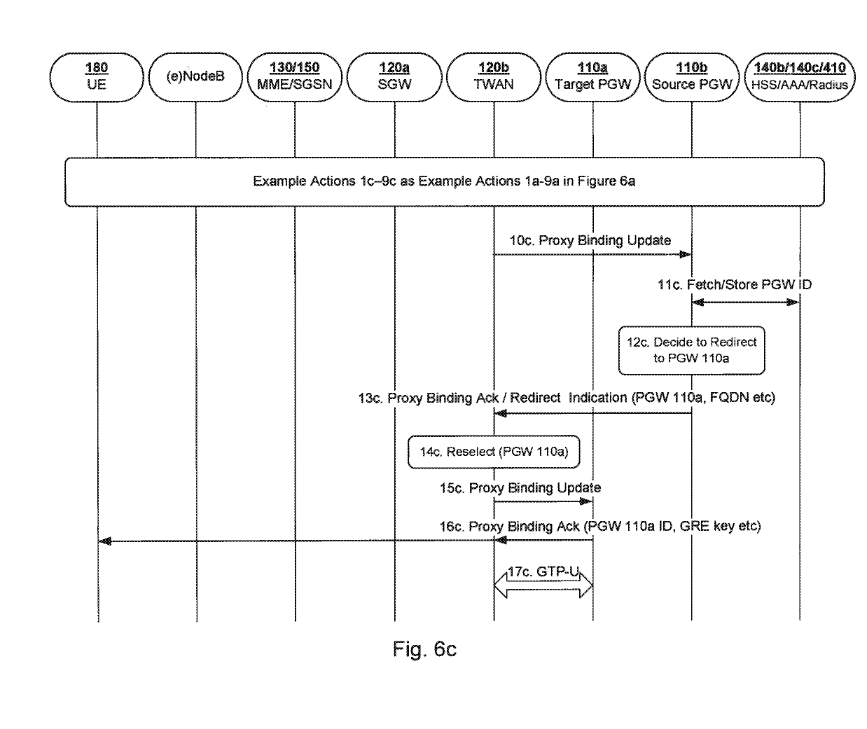

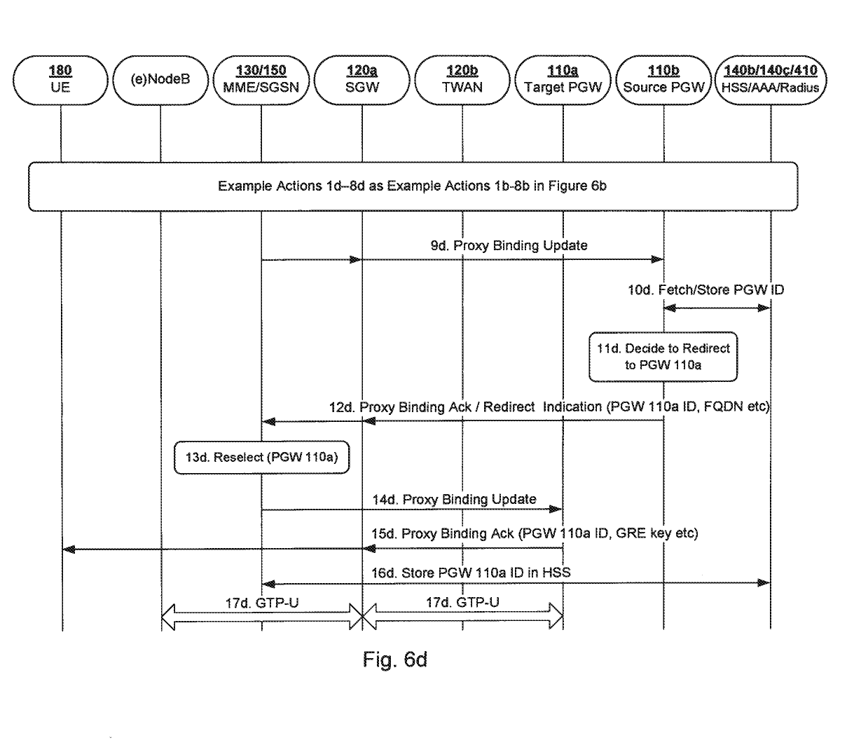

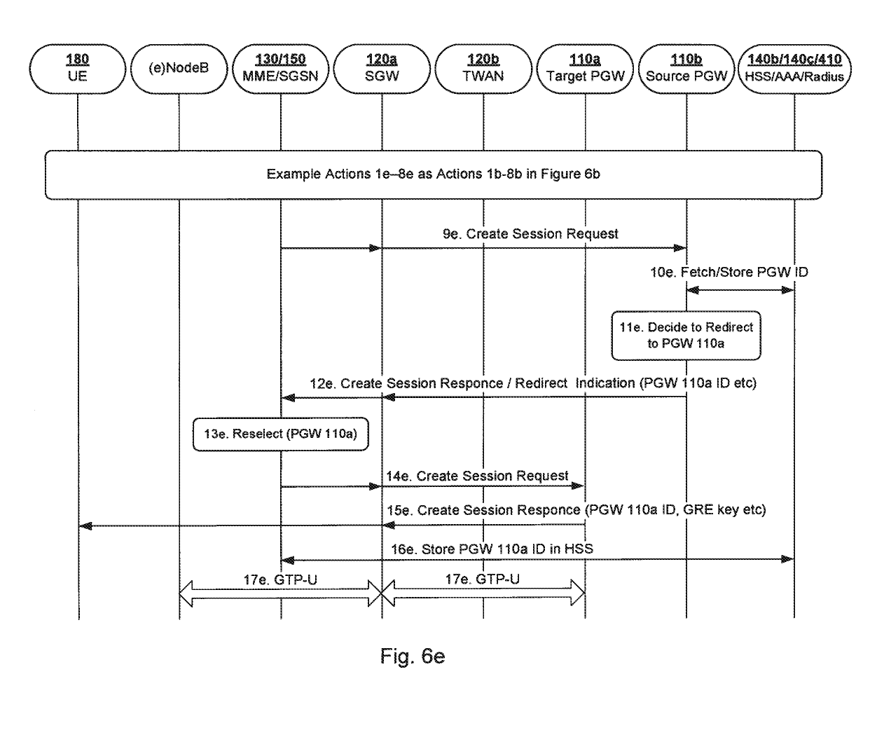

The actions A1, A2, A3a and A3b will be briefly discussed below, and in more detail in connection with the discussion of the signaling diagrams in FIGS. 6a-6e.

Action 1:

In a first exemplifying action A1 it is preferred that the source network gateway receives a message from an initiating node arrangement signaling the setup of a new communication path between the radio terminal and a peer node via the source network gateway node.

The message may e.g. be received from an initiating node arrangement, e.g. in the form of a SGW 120a, or a SGSN 150, or a MME 130 or a TWAN 120b or similar, e.g. from the WLAN Access Network (WLAN AN) and/or from the Trusted WLAN Access Gateway (TWAG) in the TWAN 120b or similar.

Action 2:

In a second exemplifying action A2 it is preferred that the source network gateway determines whether there already is an existing communication path established for the radio terminal via a target network gateway.

The determining may e.g. be done in that the source network gateway obtains information about the existence of a possible target network gateway node for the radio terminal from a storing function, e.g. such as an AAA function or a HSS function or a RADIUS server or similar. Here it is assumed that the storing function is configured with such information, i.e. information about the existence of a possible target network gateway node for the radio terminal. This may e.g. be accomplished according to the actions discussed below in connection with Example Action 4a or 4b.

As indicated in said Example Action 4a and 4b it is preferred that a storing function (e.g. the AAA Server 140b or the HSS 140c or a separate RADIUS server 410) is configured with information indicting the identity of the target network gateway when there is an established existing communication path for the radio terminal via a target network gateway. It is preferred that the source network gateway obtains such information from the storing function indicting the identity of the target network gateway when checking whether there is an existing communication path for a radio terminal.

Action 3a:

In a third exemplifying action A3a it is preferred that the source network gateway initiate a redirect of the new communication path if there is an established existing communication path, such that the redirected new communication path is also established between the radio terminal and the peer node via the target network gateway. The source network gateway may initiate and execute the redirection or the source network gateway may only initiate the redirect while one or more other network nodes or similar executes the actual redirecting.

A redirect of the new communication path may e.g. be performed by obtaining from the target network gateway, based on the redirecting information, session data for the radio terminal at least indicating an address of the target network gateway, and by sending the obtained session data to the initiating node arrangement for establishing the new communication path via the target network gateway node.

A redirect of the new communication path may be performed by forwarding from the source network gateway node the received establishing message to the target network node based on the redirecting information, and by sending from the target network node to the initiating node arrangement, session data for the radio terminal at least indicating an address of the target network gateway for establishing the new communication path via the target network gateway node.

A redirect of the new communication path may be performed by sending from the source network gateway node the redirecting information to the initiating node arrangement based on the redirecting information for establishing the new communication path via the target network gateway node.

Action 3b:

In a fourth exemplifying action A3b it is preferred that the source network gateway establishes a communication path between the radio terminal and the peer via the source network gateway when there is no existing communication path established for the radio terminal via a target network gateway node. It is preferred that the source network gateway stores information indicating that there now exist an established communication path for the radio terminal via the source network gateway. It is preferred that the information indicates the identity of the source network gateway node. Here, the source network gateway and the target network gateway is one and the same gateway, since there is no previous network gateway node via which an existing communication path is already established for the radio terminal as required in action 3a discussed above. The information indicating that there now is an established existing communication path between the radio terminal and the peer node via a target network gateway node may e.g. be stored internally by source network gateway, e.g. in the internal memory 120 shown in FIG. 4b. Alternatively, the information indicating that there now is an established existing communication path may be stored by the source network gateway in a storing function, e.g. in an entity such as the HSS 140c and/or in the 3GPP AAA Server 140a shown in FIG. 3.

FIG. 6a illustrates a signaling diagram depicting one exemplifying manner of performing the actions of the flow diagram in FIG. 5. Here, a first communication path 182 is established in 3GPP access via a target network gateway (PGW 110a), whereas the establishment in WLAN access of a second communication path 184 is redirected from a source network node (PGW 110b) to the target network node.

Example Action 1a:

In a first exemplifying action 1a it is preferred that the UE 180 makes a first initial attach in 3GPP access. This may e.g. be done by sending an attach request to the MME 130 via an eNodeB in the E-UTRAN 160. It is preferred that the attach signals the setup of a first communication path 182 between the UE 180 and the peer node 190.

Example Action 2a:

In a second exemplifying action 2a it is preferred that the MME 130 makes a new PGW selection by selecting PGW 110a as the target network gateway node.

Example Action 3a:

In a third exemplifying action 3a it is preferred that the MME 130 sends a Create Session Request to the SGW 120a signaling the setup of a communication path 182 between the UE 180 and the peer node 190 via the target PGW 110a. The SGW 120a forwards the message to the target PGW 110a, which receives the message.

Example Action 4a:

As per current 3GPP procedures, the PGW does not contact any AAA Server 140b or HSS 140c or similar function when the UE is active in 3GPP access. However, according to a fourth exemplifying action 4a it is preferred that the target PGW 110a checks with a storing function—e.g. such as the AAA Server 140b and/or the HSS 140c and/or a RADIUS server (see FIG. 4c)—whether there already is an existing communication path established for the UE 180 and/or APN via a PGW. It is preferred that the storing function is configured with information indicting the existence of the PGW in case there already is an established existing communication path for the UE 180 and/or APN via a PGW. The target PGW 110a may then determine whether there is an existing communication path for the UE 180 and/or APN via a PGW by obtaining information indicting the existence of a PGW for the UE 180 and/or the APN from the storing function. For example, the existence of a PGW for the UE 180/APN may be confirmed if there is stored information indicating the identity and/or the address or similar of the PGW in question, and denied if there is no such information stored.

In general, the identity of a target network gateway node (e.g. PGW 110a) may e.g. be represented by a PDN GW ID or some other identity of the target network gateway node. Similarly, the address of a target network gateway node (e.g. PGW 110a) may be an IP address and/or Generic Routing Encapsulation key (GRE-key) and/or a Fully Qualified Domain Name (FQDN) or similar.

In this example it is assumed that there is no stored information at this stage indicating the existence of a PGW for the UE 180 and/or APN. The target PGW 110a will therefore store information indicating its existence for the UE 180 and/or APN in the storing function, e.g. by storing information indicating the identity and/or address of the PGW 110a, e.g. storing its own identity and/or address or similar.

Example Action 5a:

In a fifth exemplifying action 5a it is preferred that the target PGW 110a replies to the SGW 120a with a Create Session Response message. The SGW 120a may forward the message to the MME 130, which in turn may forward the message to the UE 180.

Example Action 6a:

In a sixth exemplifying action 6a it is preferred that the MME 130 stores the selected PDN GW ID in the HSS 140c as per existing 3GPP procedures. Special measures may have to be taken with respect to this action 6a, see comments in Example Actions 14b-15b.

Example Action 7a:

In a seventh exemplifying action 7a it is preferred that user plane data for the UE 180 is sent via GTP-U between the relevant eNodeB in the E-UTRAN 160 and the target PGW 110a. With reference to FIG. 3, it is preferred that the data is further communicated by the target PGW 110a with the peer 190 via the Operator's IP Services 140 so as to establish a communication path 182 between the UE 180 and the Peer 190 via the target PGW 110a. The communication path 182 can be seen as an existing communication path compared to a new communication path 184 that will be established as described below with reference to the Example Actions 8a-16a.

Example Action 8a:

In an eight exemplifying action 8a it is preferred that the UE 180 makes a second initial attach in WLAN access. The second attach occurs after the existing communication path 182 has been established as described above. The attach signals the setup of a new communication path 184 between the UE 180 and the peer node 190. The second attach may e.g. be done by sending an attach request or similar from the UE 180 to the TWAN 120b and the WLAN Access Network therein, which may comprise one or more WLAN access points. The request it preferably sent from the UE 180 on the SWw interface.

Example Action 9a:

In a ninth exemplifying action 9a it is preferred that the TWAN 120b (e.g. the WLAN Access Network or the Trusted WLAN Access Gateway or similar of the TWAN 120b) makes a new PGW selection by selecting PGW 110b as the source network gateway node.

Example Action 10a:

In a tenth exemplifying action 10a it is preferred that the TWLAN 120b (e.g. the WLAN Access Network or the Trusted WLAN Access Gateway or similar) sends a message received by the source PGW 110b signaling the setup of a new communication path 184 between the UE 180 and the peer node 190 via the source PGW 110b. The message may e.g. be a request message, e.g. a Create Session Request message. The TWAN 120b may be seen as an initiating node arrangement signaling the establishment of the new communication path 184 between the UE 180 and the peer node 190 via the source PGW 110b.

Action 10a is one way of performing the receiving action A1 in the embodiment discussed above with reference to FIG. 5.

Example Action 11a:

As per current 3GPP procedures, the PGW 110b should store its PGW ID in the HSS 140c. However, according to an eleventh exemplifying action 11a it is preferred that the source PGW 110b checks with the storing function (e.g. the AAA Server 140b and/or the HSS 140c and/or the RADIUS server 410) whether there already is an established existing communication path for the UE 180 via a target PGW.

In this case there is an established existing communication path 182 for the UE 180 via a target PGW, since information indicating the existence of the target PGW 110a for the UE 180 was stored in the above discussed Example Action 4a.

As indicated in Example Action 4a it is preferred that the storing function is configured with information indicting the identity and/or the address of the target PGW 110a when there is an established existing communication path for the UE 180 and/or APN via a target PGW 110a.

When the source PGW 110b checks the existence of a target PGW with the storing function as indicated above it is preferred that the source PGW 110b obtains information from the storing function indicting the identity and/or address or similar of the target PGW 110a.

Action 11a—possibly together with action 12a—is one way of performing the checking action A2 in the embodiment discussed above with reference to FIG. 5.

Example Action 12a:

In a twelfth exemplifying action 12a it is preferred that the source PGW 110b decides to initiate a redirect of the setup of the new communication path 184—since the there already is an established existing communication path 182 via a target PGW 110a—such that the redirected new communication path 184 is also established between the UE 180 and the peer 190 via the target PGW 110a.

Action 12a—possibly together with action 13a and possibly together with action 14a—is one way of performing the initiating action A3 in the embodiment discussed above with reference to FIG. 5.

Example Action 13a:

In a thirteenth exemplifying action 13a it is preferred that the source PGW 110b obtains (e.g. requests) session data for the UE 180 from the target PGW 110a. The session data may e.g. be GTP session data or similar. The session data may e.g. comprise information indicating the identity of and/or address to the target PGW 110a. The address may e.g. be the IP-address and/or the TEID and/or F-TEID for the target PGW 110a. Once such session data is provided to the initiating node arrangement, which in this example is the TWAN 120b (c.f. Example Action 10a), it enables the initiating node arrangement to communicate user plane data for the UE 180 with the target PGW 110a instead of the source PGW 110b as initially requested in the Example Action 10a. The obtaining may e.g. be done by the source PGW 110b sending a message to the target PGW 110a.

Example Action 14a:

In a fourteenth exemplifying action 14a it is preferred that the target PGW 110a provides the requested session data to the source PGW 110b. The providing may e.g. be done by the target PGW 110a sending a message to the source PGW 110b.

Example Action 15a:

In a fifteenth exemplifying action 15a it is preferred that the source PGW 110b replies to the TWAN 120b by sending a message containing the session data received from the target PGW 110a. The message may e.g. be a Create Session Response message. The TWAN 120b may forward the session data in part or in full to the UE 180. However, it is preferred that the session data is kept internally in the wireless communication network 100 and that the TWAN 120b simply sends an acknowledge message or similar to the UE 180.

However, before proceeding to Example Action 16a it should be mentioned that Example Actions 13a-15a now discussed may be replaced by alternative Example Actions 13a′-14a′ as indicated by dashed lines in FIG. 6a.

Example Action 13a′:

In an alternative embodiment it is preferred that the thirteenth Example Action 13a discussed above is replaced by an alternative thirteenth Example Action 13a′. In the alternative Example Action 13a′ it is preferred that the source PGW 110b simply forwards the establishing message received in Example Action 10a (e.g. the Create Session Request message received by the source PGW 110b) to the target PGW 110a. The forwarding action is preferably performed based on the information obtained in Example Action 11a discussed above, which information at least indicates the identity of the target PGW 110a.

Example Action 14a′:

In an alternative embodiment it is preferred that the Example Actions 14a-15a discussed above are replaced by an alternative fourteenth Example Action 14a′. In the alternative Example Action 14a′ it is preferred that the target PGW 110a sends session data for the UE 180 to the TWAN 120b for establishing the new communication path 184 via the target PGW 110a. It is preferred that the session data at least indicates an address of the target network gateway 110a. It is well known that various session data for a radio terminal (e.g. UE 180) served by a network gateway node (e.g. PGW 110a) may be comprised by the node in question. It is well known that a network gateway node may comprise information indicating its own identity and/or address or similar.

Example Action 16a:

In a sixteenth exemplifying action 16a it is preferred that the TWAN 120b communicates user plane data for the UE 180 on the new path 184 via the target PGW 110a instead of the source PGW 110b as initially requested in Example Action 10a. This is enabled by the session data that was received by the TWAN 120b from the source PGW 110b in Example Action 15a. For example, all continued communication on path 184 using GTP may now take place between the TWAN 120b and the target PGW 110a. For example, user plane data encapsulated in GTP-U will be communicated between the TWAN 120b and target PGW 110a. For example, all continued communication on the new path 184 may now take place between the TWAN 120a and the target PGW 110a via a GTP tunnel, which e.g. may be identified by one or more Tunnel Endpoint Identifier(s) (TEID).

FIG. 6b illustrates a signaling diagram depicting another exemplifying manner of performing the actions of the flow diagram in FIG. 5. Here, a first communication path 184 is established in WLAN access via a target network gateway (PGW 110a), whereas the establishment in 3GPP access of a second communication path 182 is redirected from a source network node (PGW 110b) to the target network node.

Example Action 1b:

In a first exemplifying action 1b it is preferred that the UE 180 makes a first initial attach in WLAN access. This may e.g. be done by sending an attach request or similar to the TWAN 120b and the WLAN Access Network therein comprising one or more WLAN access points. It is preferred that the attach signals a setup of a first communication path 184 between the UE 180 and the peer node 190. The request is preferably sent by the UE 180 and received by the WLAN Access Network on the SWw interface.

Example Action 2b:

In a second exemplifying action 2b it is preferred that the TWAN 120b makes a new PGW selection by selecting PGW 110a as the target network gateway node. The selection may e.g. be done by the Trusted WLAN Access Gateway in the TWAN 120b.

Example Action 3b:

In a third exemplifying action 3b it is preferred that the TWAN 130 sends a Create Session Request to the SGW 120a signaling the setup of a communication path 184 between the UE 180 and the peer node 190 via the target PGW 110a. The SGW 120a forwards the message to the target PGW 110a, which receives the message.

Example Action 4b:

As per current 3GPP procedures, the PGW does not contact any AAA Server 140b or HSS 140c or similar function when the UE is active in WLAN access. However, according to a fourth exemplifying action 4b it is preferred that the target PGW 110a checks with a storing function whether there already is an established existing communication path for the UE 180 via a PGW.

This action is the same as the Exemplifying Action 4a, discussed with reference to FIG. 6a.

Thus, it is assumed that there is no stored information at this stage indicating the existence of a PGW for the UE 180 and/or APN. The target PGW 110a will therefore store information indicating its existence for the UE 180 and/or APN in the storing function, e.g. by storing information indicating the identity and/or address of the PGW 110a, e.g. storing its own identity and/or address or similar.

Example Action 5b:

In a fifth exemplifying action 5b it is preferred that the target PGW 110a replies to the TWAN 120b with a Create Session Response message. The TWAN 120b may forward the message to the UE 180.

Example Action 6b:

In a sixth exemplifying action 6b it is preferred that user plane data for the UE 180 is sent via GTP-U between the TWAN 120b and the target PGW 110a. With reference to FIG. 3, it is preferred that the data is further communicated by the target PGW 110a with the peer 190 via the Operator's IP Services 140 so as to establish a communication path 184 between the UE 180 and the Peer 190 via the target PGW 110a. The communication path 184 can be seen as an existing communication path compared to a new communication path 182 that will be established as described below with reference to the Example Actions 7b-16b.

Example Action 7b:

In a seventh exemplifying action 7b it is preferred that the UE 180 makes a second initial attach in 3GPP access. The second attach occurs after the existing communication path 184 has been established as described above. The second attach signals a setup of a new communication path 182 between the radio terminal 180 and the peer node 190. The second attach may e.g. be done by sending an attach request from the UE 180 to the MME 130 via an eNodeB in the E-UTRAN 160.

Example Action 8b:

In an eight exemplifying action 8b it is preferred that the MME 130 makes a new PGW selection by selecting PGW 110b as the source network gateway node.

Example Action 9b:

In a ninth exemplifying action 9b it is preferred that the MME 130 sends a message, e.g. a Create Session Request message or similar to the SGW 120a signaling the setup of a new communication path 182 between the UE 180 and the peer node 190 via the source PGW 110b. The SGW 120a forwards the message to be received by the source PGW 110b. The MME 130 and/or the SGW 12a may be seen as an initiating node arrangement signaling the establishment of the new communication path 182 between the UE 180 and the peer node 190 via the source PGW 110b.

The message is sent by the MME 130 as a result of the selection of a source PGW 110b by the MME 130 in Example Action 8b.

Action 9b is one way of performing the receiving action A1 in the embodiment discussed above with reference to FIG. 5.

Example Action 10b:

As per current 3GPP procedures, the PGW 110b should store its PGW ID in the HSS 140c. However, according to a tenth exemplifying action 10b it is preferred that the source PGW 110b checks with a storing function (e.g. the AAA Server 140b and/or the HSS 140c and/or the RADIUS server 410 or similar) whether there already is an established existing communication path for the UE 180 via a target PGW.

In this case there is an established existing communication path 184 for the UE 180 via a target PGW, since information indicating the existence of the target PGW 110a for the UE 180 was stored in the above discussed Example Action 4b.

As indicated in Example Actions 4a-4b it is preferred that the storing function is configured with information indicting the identity and/or the address of the target PGW 110a when there is an established existing communication path for the UE 180 and/or APN via a target PGW 110a.

When the source PGW 110b checks the existence of a target PGW with the storing function as indicated above it is preferred that the source PGW 110b obtains information from the storing function indicting the identity and/or address or similar of the target PGW 110a.

Action 10b—possibly together with action 11b—is one way of performing the checking action A2 in the embodiment discussed above with reference to FIG. 5.

Example Action 11b:

In an eleventh exemplifying action 11b it is preferred that the source PGW 110b decides to initiate a redirect of the setup of the new communication path 182—since there already is an established existing communication path 184 via a target PGW 100a—such that the redirected new communication path 182 is also established between the UE 180 and the peer 190 via the target PGW node 110a.

Action 11b—possibly together with action 12b and possibly together with action 13b—is one way of performing the initiating action A3 in the embodiment discussed above with reference to FIG. 5.

Example Action 12b:

In a twelfth exemplifying action 12b it is preferred that the source PGW 110b obtains (e.g. requests) session data for the UE 180 from the target PGW 110a. The session data may e.g. be GTP session data or similar. The session data may e.g. comprise information indicating the identity of and/or address to the target PGW 110a. The address may e.g. be the IP-address and/or the TEID and/or F-TEID for the target PGW 110a. Once such session data is provided to the initiating node arrangement, which in this example is the MME 130 and/or the SGW 120a (c.f. Example Action 9b), it enables the initiating node arrangement to communicate user plane data for the UE 180 with the target PGW 110a instead of the source PGW 110b as initially requested in the Example Action 9b. The obtaining may e.g. be done by the source PGW 110b sending a message to the target PGW 110a.

Example Action 13b:

In a thirteenth exemplifying action 13b it is preferred that the target PGW 110a provides the requested session data to the source PGW 110b. The providing may e.g. be done by the target PGW 110a sending a message to the source PGW 110b.

Example Action 14b:

In a fourteenth exemplifying action 14b it is preferred that the source PGW 110b replies to the SGW 120a by sending a message containing session data received from the target PGW 110a. The message may e.g. be a Create Session Response message. The SGW 120a may forward the session data to the MME 130 and the UE 180. However, it is preferred that the session data is kept internally in the wireless communication network 100 and that the SGW 120a simply sends an acknowledge message or similar to the UE 180.

Here, one detail is worth pointing out. When the MME 130 has made a new PGW selection as indicated in the Example Action 8b discussed above the MME 130 will, according to current 3GPP specifications store the selected PDN GW ID in the HSS 140b (see Example Action 15b discussed below). Since the MME 130 selected the source PGW 110b in Example Action 8b and the MME 130 is unaware of the PGW re-direction it will store the PDN GW ID for PGW 110b in the HSS 140b. This creates a problem since the PDN GW ID for the actually used PGW (target PGW 110a) is over-written in the HSS 140b. In order to prevent or mitigate this, different solutions are possible:

(i) The message sent by the source PGW 110b in Example Action 14b contains the identity of the target PGW (PGW 110a in this case), which was obtained in Example Action 10b discussed above. The MME 130/SGSN 150 uses this as the selected PGW instead of the one selected in Example Action 8b. The MME 130/SGSN 150 thus provides the identity of PGW 110a instead of PGW 110b to the HSS 140b in Example Action 15b. This will affect the behavior of the source PGW 110b and the behavior of the MME 130/SGSN 150.

(ii) Another solution is that the wireless communication network 100 (se FIG. 3) that supports PGW redirection for multipath communication (e.g. such as MPTCP) ensures that the HSS 140b does not store PGW IDs received from MME 130/SGSN 150. This option avoids impact on the MME/SGSN but does instead have impact on the behavior of the HSS 140b.

(iii) Yet another solution, avoiding impacts on both HSS and MME/SGSN, is that the PGWs 110a and 110b store the identity and/or address of the PGW (e.g. the PDN GW ID) in a separate storing function, e.g. a RADIUS Server or similar. The PGW would then use this stored identity and/or address instead of the PDN GW ID stored in the HSS 140b for making redirect decisions. The MME/SGSN may still update the HSS 140c as per current 3GPP specifications.

The option comprising a separate storing function is shown in FIG. 4c illustrating a part of the wireless communication network 100 described above with reference to FIG. 3, however now with the addition of a storing function 410, which e.g. may be implemented in the form of a RADIUS server. Both the target PGW 110a and the source PGW 110b may be connected to the storing function 410 and thus configured to store the identity of the target PGW 110a as indicated above.

However, before proceeding to Example Action 15b it should be mentioned that Example Actions 12b-14b may be replaced by the alternative Example Actions 12b′-13b′ indicated by dashed lines in FIG. 6b.

Example Action 12b′:

In an alternative embodiment it is preferred that the twelfth Example Action 12b discussed above is replaced by an alternative thirteenth Example Action 12b′. In the alternative Example Action 12b′ it is preferred that the source PGW 110b simply forwards the establishing message received in Example Action 9b (e.g. the Create Session Request message received by the source PGW 110b) to the target PGW 110a. The forwarding action is preferably performed based on the information obtained in Example Action 10b discussed above, which information at least indicates the identity of the target PGW 110a.

Example Action 13b′:

In an alternative embodiment it is preferred that the Example Actions 13b-14b discussed above are replaced by an alternative thirteenth Example Action 13b′. In the alternative Example Action 13b′ it is preferred that the target PGW 110a sends session data for the UE 180 to the SGW 120a for establishing the new communication path 182 via the target PGW 110a. In turn, the SGW 120a may forward the session data to the MME 130. It is preferred that the session data at least indicates an address of the target network gateway 110a. It is well known that various session data for a radio terminal (e.g. UE 180) served by a network gateway node (e.g. PGW 110a) may be comprised by the node in question. It is well known that a network gateway node may comprise information indicating its own identity and/or address or similar.

Example Action 15b:

In a fifteenth exemplifying action 15b it is preferred that the MME 130 stores the selected PDN GW ID in the HSS 140c as per existing 3GPP procedures. This may create problems, as mentioned above in connection with Example Action 14b, since the PDN GW ID for the actually used PGW (target PGW 110a) is over-written in the HSS 140b. In order to avoid this, different solutions were suggested in connection with Example Action 14b.

Example Action 16b:

In a sixteenth exemplifying action 16b it is preferred that the SGW 120a communicates user plane data for the UE 180 on the new path 182 via the target PGW 110a instead of the source PGW 110b as initially requested in Example Action 9b. This is enabled by the session data that was received by the SGW 120a from the source PGW 110b in Example Action 14b. For example, all continued communication on path 182 using GTP may now take place between the target PGW 110a and the SGW 120a. For example, user plane data encapsulated in GTP-U will be communicated between the SGW 120a and the target PGW 110a.

FIG. 6c illustrates a signaling diagram depicting another exemplifying manner of performing the actions of the flow diagram in FIG. 5. Here, a first communication path 182 is established in 3GPP access via a target network gateway (PGW 110a), whereas the establishment in WLAN access of a second communication path 184 is redirected from a source network node (PGW 110b) to the target network node.

Example Actions 1c-9c (shown in a single bar in FIG. 6c) are the same or at least very similar to Example Actions 1a-9a respectively discussed above with reference to FIG. 6a. For example, this means that there is an existing communication path 182 between the UE 180 and the peer 190 via the target PGW 110a when Example Action 10c is executed.

Example Actions 10a-16a in FIG. 6a are replaced by Example Actions 10c-17c in FIG. 6c.

Example Action 10c:

In a tenth exemplifying action 10c it is preferred that the TWAN 120b (e.g. the WLAN Access Network or the Trusted WLAN Access Gateway or similar) sends a message received by the source PGW 110b signaling the setup of a new communication path 184 between the UE 180 and the peer node 190 via the source PGW 110b. The message may e.g. be a request message, e.g. a binding update request or a Proxy Binding Update request or a Create Session Request or similar.

It may be added that the properties and functions of a binding update or similar are well known to persons skilled in the art. For example, it is well known that a binding update such as a proxy binding update may e.g. be a request message sent by a mobile access gateway to a local mobility anchor (e.g. a PGW or similar) of a mobile radio terminal (e.g. the UE 180 or similar) for establishing a binding between the home network of the mobile radio terminal and its current care-of address.

The message sent in Example Action 10c may be sent by the WLAN Access Network or the Trusted WLAN Access Gateway or similar of the TWLAN 120b. The TWAN 120b may be seen as an initiating node arrangement signaling the establishment of the new communication path 184 between the UE 180 and the peer node 190 via the source PGW 110b. The message is sent by the TWAN 120b as a result of the selection of a new source PGW 110b by the TWAN 120b, e.g. as indicated in the above discussion of Example Action 9a.

Action 10c is one way of performing the receiving action A1 in the embodiment discussed above with reference to FIG. 5.

Example Action 11c:

As per current 3GPP procedures, the PGW 110b should store its PGW ID in the HSS 140c. However, according to an eleventh exemplifying action 11a it is preferred that the source PGW 110b checks with the storing function (e.g. the AAA Server 140b and/or the HSS 140c and/or the RADIUS server 410) whether there already is an established existing communication path for the UE 180 via a target PGW.

In this case there is an established existing communication path 182 for the UE 180 via a target PGW, since information indicating the existence of the target PGW 110a for the UE 180 is stored in Example Action 4c, which preferably is the same as the above discussed Example Action 4a.

As indicated in Example Action 4a it is preferred that the storing function is configured with information indicting the identity and/or the address of the target PGW 110a when there is an established existing communication path for the UE 180 and/or APN via a target PGW 110a.

When the source PGW 110b checks the existence of a target PGW with the storing function as indicated above it is preferred that the source PGW 110b obtains information from the storing function indicting the identity and/or address or similar of the target PGW 110a.

Action 11c—possibly together with action 12c—is one way of performing the checking action A2 in the embodiment discussed above with reference to FIG. 5.

Example Action 12c:

In a twelfth exemplifying action 12a it is preferred that the source PGW 110b decides to initiate a redirect of the setup of the new communication path 184—since the there already is an established existing communication path 182 via a target PGW 110a—such that the redirected new communication path 184 is also established between the UE 180 and the peer 190 via the target PGW 110a.

Action 12c—possibly together with action 13c—is one way of performing the initiating action A3 in the embodiment discussed above with reference to FIG. 5.

Example Action 13c:

In a thirteenth exemplifying action 13c it is preferred that the source PGW 110b replies to the TWAN 120b with an acknowledgement message, e.g. a binding acknowledgment or a Proxy Binding Acknowledgement (PBA). The acknowledgement message may include an indication that the redirection is requested and also information indicating the identity and/or address of the target PGW 110a. For example, the address to the target PGW 110a may be an IP address or a Fully Qualified Domain Name (FQDN) or similar. The acknowledgement message may e.g. be received by the WLAN Access Network and/or the Trusted WLAN Access Gateway of the TWAN 120b.

Example Action 14c:

In a fourteenth exemplifying action 14c it is preferred that the TWAN 120b determines that a new PGW shall be selected for the new communication path 184. In particular it is preferred that the TWAN 120 selects the target PGW 110a based on the information comprised by the acknowledgement message sent by the source PGW 110b in the previous Example Action 13c. The conclusion to select the target PGW 110a may e.g. be reached by the WLAN Access Network and/or the Trusted WLAN Access Gateway of the TWAN 120b.

Example Action 15c:

In a fifteenth exemplifying action 15c it is preferred that the TWAN 120b sends a new message to the target PGW 110a signaling the setup of the new communication path 184 between the UE 180 and the peer node 190 via the target PGW 110a (not via source PGW 110a as requested in Exemplifying Action 10c). The new message may e.g. be a new request message or a new binding update request or a new Proxy Binding Update request. The new message may e.g. be sent by the WLAN Access Network or the Trusted WLAN Access Gateway or similar of the TWLAN 120b.

Example Action 16c:

In a sixteenth exemplifying action 16c it is preferred that the target PGW 110a replies to the TWAN 120b with a message containing session data for the UE 180. The session data may e.g. comprise GTP session data or similar. The session data may e.g. comprise the identity of and/or the address to the target PGW 110a. For example, the address may be an IP-address and/or the Generic Routing Encapsulation key (GRE-key) and/or the TEID and/or F-TEID for the target PGW 110a. The message may be an acknowledge message, e.g. a Binding Acknowledgement message or a Proxy Binding Acknowledgement message. It is preferred that the PGW 110a replies to the TWAN 120b and the sending entity therein (c.f. Example Action 15c), e.g. the WLAN Access Network or the Trusted WLAN Access Gateway or similar of the TWLAN 120b.

It may be added that it is well known that various session data for a radio terminal (e.g. UE 180) served by a network gateway node (e.g. PGW 110a) may be comprised by the node in question. It is well known that a network gateway node may comprise information indicating its own identity and/or address or similar. Once the session data is provided to the initiating node arrangement, which in this example is the TWAN 120b (c.f. Example Action 10c), it enables the initiating node arrangement to communicate user plane data for the UE 180 with the target PGW 110a instead of the source PGW 110b as initially requested in Example Action 10c.

Example Action 17c:

In a seventeenth exemplifying action 17c it is preferred that the TWAN 120b communicates user plane data for the UE 180 on the new path 184 via the target PGW 110a instead of the source PGW 110b as initially requested in Example Action 9b. This is enabled by the session data that was received by the TWAN 120b from the target PGW 110a in Example Action 16c. For example, all continued communication on path 184 using GTP may now take place between the target PGW 110a and the SGW 120a. For example, user plane data encapsulated in GTP-U will be communicated between the SGW 120a and the target PGW 110a. For example, all continued communication on the new path 184 may now take place between the TWAN 120a and the target PGW 110a via a GTP tunnel, which e.g. may be identified by one or more Tunnel Endpoint Identifier(s) (TED).

FIG. 6d illustrates a signaling diagram depicting another exemplifying manner of performing the actions of the flow diagram in FIG. 5. Here, a first communication path 184 is established in WLAN access via a target network gateway (PGW 110a), whereas the establishment in 3GPP access of a second communication path 182 is redirected from a source network node (PGW 110b) to the target network node.

Example Actions 1d-8d (shown in a single bar in FIG. 6d) are the same or at least very similar to Example Actions 1b-8b respectively discussed above with reference to FIG. 6b. For example, this means that there already is an existing communication path 184 between the UE 180 and the peer 190 via the target PGW 110a when Example Action 9d is executed.

Example Actions 9b-16b in FIG. 6b are replaced by Example Actions 9d-17d in FIG. 6d.

Example Action 9d:

In a ninth exemplifying action 9a it is preferred that the MME 130 sends a binding update request or a Proxy Binding Update request or a Create Session Request or a similar message to the SGW 120a signaling the setup of a new communication path 182 between the UE 180 and the peer node 190 via the source PGW 110b. The SGW 120a forwards the message to be received by the source PGW 110b. The MME 130 and/or the SGW 12a may be seen as an initiating node arrangement signaling the establishment of the new communication path 182 between the UE 180 and the peer node 190 via the source PGW 110b.

The message is sent by the MME 130 as a result of the selection of a source PGW 110b by the MME 130 in Example Action 8d corresponding to Example Action 8b.

Action 9d is one way of performing the receiving action A1 in the embodiment discussed above with reference to FIG. 5.

Example Action 10d:

As per current 3GPP procedures, the PGW 110b should store its PGW ID in the HSS 140c. However, according to a tenth exemplifying action 10b it is preferred that the source PGW 110b checks with a storing function (e.g. the AAA Server 140b and/or the HSS 140c and/or the RADIUS server 410) whether there already is an established existing communication path for the UE 180 via a target PGW.

In this case there is an established existing communication path 184 for the UE 180 via a target PGW, since information indicating the existence of the target PGW 110a for the UE 180 is stored in Example Action 4d corresponding to Example Actions 4a-4b.

As indicated in Example Actions 4a-4b it is preferred that the storing function is configured with information indicting the identity and/or the address of the target PGW 110a when there is an established existing communication path for the UE 180 and/or APN via a target PGW 110a.

When the source PGW 110b checks the existence of a target PGW with the storing function as indicated above it is preferred that the source PGW 110b obtains information from the storing function indicting the identity and/or address or similar of the target PGW 110a.

Action 10d—possibly together with action 11d—is one way of performing the checking action A2 in the embodiment discussed above with reference to FIG. 5.

Example Action 11d:

In an eleventh exemplifying action 11d it is preferred that the source PGW 110b decides to initiate a redirect of the setup of the new communication path 182—since the there already is an established existing communication path 184 via a target PGW 110a—such that the redirected new communication path 182 is also established between the UE 180 and the peer 190 via the target PGW 110a.

Action 11d—possibly together with action 12d—is one way of performing the initiating action A3 in the embodiment discussed above with reference to FIG. 5.

Example Action 12d:

In a twelfth exemplifying action 12d it is preferred that the source PGW 110b replies to the SGW 120a with a message, e.g. an acknowledgement message, e.g. a Proxy Binding Acknowledgement (PBA). The SGW 120a may forward the message to the MME 130. The message may include an indication that a redirection is requested and also information indicating the identity and/or address of the target PGW 110a. For example, the address to the target PGW 110a may be an IP address or a Fully Qualified Domain Name (FQDN) or similar.

Example Action 13d:

In a thirteenth exemplifying action 13d it is preferred that the MME 130 determines that a new PGW shall be selected for the new communication path 182. It is preferred that the MME 130 selects the target PGW 110a based on the information comprised by the acknowledgement message sent by the source PGW 110b in the previous Example Action 12d.

Example Action 14d:

In a fourteenth exemplifying action 14d it is preferred that the MME 130 sends a new message to the target PGW 110a via the SGW 120a signaling the setup of the new communication path 184 between the UE 180 and the peer node 190 via the target PGW 110a (not via source PGW 110a as requested in Exemplifying Action 10c). The message may e.g. be a new request message or a new binding update request or a new Proxy Binding Update request.

Example Action 15d:

In a fifteenth exemplifying action 15d it is preferred that the target PGW 110a replies to the SGW 120a with a message containing session data for the UE 180. The session data may e.g. comprise GTP session data or similar. The session data may e.g. comprise the identity of and/or the address to the target PGW 110a. For example, the address may be an IP-address and/or the Generic Routing Encapsulation key (GRE-key) and/or the TED and/or F-TEID for the target PGW 110a. The message may be an acknowledge message, e.g. a Binding Acknowledgement message or a Proxy Binding Acknowledgement message.

Example Action 16d:

In a sixteenth exemplifying action 16c it is preferred that the MME 130 stores the selected PDN GW ID in the HSS 140c as per existing 3GPP procedures. This action corresponds to the Example Action 15b.

Example Action 17d:

In a seventeenth exemplifying action 17d it is preferred that the SGW 120a communicates user plane data for the UE 180 on the new path 182 via the target PGW 110a instead of the source PGW 110b as initially requested in Example Action 9d. This is enabled by the session data that was received by the SGW 120a from the target PGW 110a in Example Action 15d. For example, all continued communication on path 182 using GTP may now take place between the target PGW 110a and the SGW 120a. For example, user plane data encapsulated in GTP-U will be communicated between the SGW 120a and the target PGW 110a. For example, all continued communication on the new path 182 may now take place between the SGW 120a and the target PGW 110a via a GTP tunnel, which e.g. may be identified by one or more Tunnel Endpoint Identifier(s) (TEID).

FIG. 6e illustrates a signaling diagram depicting another exemplifying manner of performing the actions of the flow diagram in FIG. 5. Here, a first communication path 184 is established in WLAN access via a target network gateway (PGW 110a), whereas the establishment in 3GPP access of a second communication path 182 is redirected from a source network node (PGW 110b) to the target network node.

Example Actions 1e-8e (shown in a single bar in FIG. 6e) are the same or at least very similar to Example Actions 1b-8b respectively discussed above with reference to FIG. 6b. For example, this means that there already is an existing communication path 184 between the UE 180 and the peer 190 via the target PGW 110a when Example Action 9e is executed.

Example Actions 9b-16b in FIG. 6b are replaced by Example Actions 9e-17e in FIG. 6e.

Example Action 9e:

In a ninth exemplifying action 9e it is preferred that the MME 130 sends a message, e.g. a Create Session Request message or similar to the SGW 120a signaling the setup of a new communication path 182 between the UE 180 and the peer node 190 via the source PGW 110b. The SGW 120a forwards the message to be received by the source PGW 110b. The MME 130 and/or the SGW 12a may be seen as an initiating node arrangement signaling the establishment of the new communication path 182 between the UE 180 and the peer node 190 via the source PGW 110b.

The message is sent by the MME 130 as a result of the selection of a source PGW 110b by the MME 130 in Example Action 8e, which corresponds to Example Action 8b.

Action 9e is one way of performing the receiving action A1 in the embodiment discussed above with reference to FIG. 5.

Example Action 10e:

As per current 3GPP procedures, the PGW 110b should store its PGW ID in the HSS 140c. However, according to a tenth exemplifying action 10e it is preferred that the source PGW 110b checks with a storing function (e.g. the AAA Server 140b and/or the HSS 140c and/or the RADIUS server 410 or similar) whether there already is an established existing communication path for the UE 180 via a target PGW.

In this case there is an established existing communication path 184 for the UE 180 via a target PGW, since information indicating the existence of the target PGW 110a for the UE 180 is stored in Example Action 4e, corresponding to Example Action 4b.

As indicated in Example Actions 4a-4b it is preferred that the storing function is configured with information indicting the identity and/or the address of the target PGW 110a when there is an established existing communication path for the UE 180 and/or APN via a target PGW 110a.

When the source PGW 110b checks the existence of a target PGW with the storing function as indicated above it is preferred that the source PGW 110b obtains information from the storing function indicting the identity and/or address or similar of the target PGW 110a.

Action 10e—possibly together with action 11e—is one way of performing the checking action A2 in the embodiment discussed above with reference to FIG. 5.

Example Action 11e:

In an eleventh exemplifying action 11e it is preferred that the source PGW 110b decides to initiate a redirect of the setup of the new communication path 182—since there already is an established existing communication path 184 via a target PGW 100a—such that the redirected new communication path 182 is also established between the UE 180 and the peer 190 via the target PGW node 110a.

Action 11e—possibly together with action 12e—is one way of performing the initiating action A3 in the embodiment discussed above with reference to FIG. 5.

Example Action 12e:

In a twelfth exemplifying action 12e it is preferred that the source PGW 110b responds to the SGW 120a with a message, e.g. a response message, e.g. a create session response message or similar. The SGW 120a may forward the message to the MME 130. The message may include an indication that a redirection is requested and also information indicating the identity and/or address of the target PGW 110a. For example, the address to the target PGW 110a may be an IP address or a Fully Qualified Domain Name (FQDN) or similar.

Example Action 13e:

In a thirteenth exemplifying action 13e it is preferred that the MME 130 determines that a new PGW shall be selected for the new communication path 182. It is preferred that the MME 130 selects the target PGW 110a based on the information comprised by the message sent by the source PGW 110b in the previous Example Action 12e.

Example Action 14e:

In a fourteenth exemplifying action 14e it is preferred that the MME 130 sends a message e.g. a Create Session Request message to the SGW 120a signaling the setup of a new communication path 182 between the UE 180 and the peer node 190 via the target PGW 110a. The SGW 120a forwards the message to be received by the target PGW 110a.

Example Action 15e:

In a fifteenth exemplifying action 15e it is preferred that the target PGW 110a replies to the SGW 120a with a message, e.g. a create session response message, containing session data for the UE 180. The session data may e.g. comprise GTP session data or similar. The session data may e.g. comprise the identity of and/or the address to the target PGW 110a. For example, the address may be an IP-address and/or the Generic Routing Encapsulation key (GRE-key) and/or the TEID and/or F-TEID for the target PGW 110a.

In a fifteenth exemplifying action 15e it is preferred that the target PGW 110a responds to the SGW 120a by sending a message containing session data. The session data may e.g. comprise the address for the target PGW 110a, e.g. the IP-address and/or the Generic Routing Encapsulation key (GRE-key) and/or the TEID and/or F-TEID for the target PGW 110a or similar. The SGW 120a may forward the session data to the MME 130 and/or the SGSN 150 and the UE 180.

Example Action 16e:

In a sixteenth exemplifying action 16e it is preferred that the MME 130 stores the selected PDN GW ID in the HSS 140c as per existing 3GPP procedures. This action corresponds to the Example Action 15b.

Example Action 17e:

In a seventeenth exemplifying action 17e it is preferred that the SGW 120a communicates user plane data for the UE 180 on the new path 182 via the target PGW 110a instead of the source PGW 110b as initially requested in Example Action 9e. This is enabled by the session data that was received by the SGW 120a from the source PGW 110b in Example Action 15e. For example, all continued communication on path 182 using GTP may now take place between the target PGW 110a and the SGW 120a. For example, user plane data encapsulated in GTP-U will be communicated between the SGW 120a and the target PGW 110a.

Embodiments of the present solution have now been described above. Before proceeding it can be mentioned that GPRS Tunneling Protocol (GTP) is typically used between SGW 120a and the PGW 110a/110b, and also between the TWAN 120b and the PGW 110a/110b. However, PMIP may be used instead. It is also possible to mix these deployments; e.g. GTP is used between SGW-PGW and Proxy Mobile IP (PMIP) is used between TWAN-PGW.

Moreover, the source PGW making the redirect is typically only on the signaling path for the first messages (e.g. including Create Session Request or similar). All further GTP-C (control plane) and GTP-U (user plane) messages go to the target PGW. As an alternative solution, the GTP-C signaling may stay on the source PGW making the redirect while the user plane (GTP-U) goes directly to the target PGW. This can e.g. be accomplished if the source PGW making the redirect sends the user plane F-TEID for the target PGW while it sends its own control plane F-TEID.

Some embodiments described above may be summarized in the following manner:

One embodiment is directed to a method in a source network gateway node for redirecting a communication path between a peer node and a radio terminal that supports multipath communication with the peer node so as to enable a plurality of communication paths between the radio terminal and the peer node. The method comprises the actions of: receiving an establishing message from a signaling node arrangement signaling the establishment of a new communication path between the radio terminal and the peer node via the source network gateway node, and determining whether there already is an existing communication path for the radio terminal via a target network gateway node, and initiating a redirect of the new communication path if there is an existing communication path such that the redirected new communication path is established via the target network gateway node.

The determining may be done by obtaining redirecting information at least indicating one of; an identity of or an address to the target network gateway node, from a storing function comprising such redirecting information.

The redirect of the new communication path may be performed by the actions of: obtaining, from the target network gateway based on the redirecting information, session data for the radio terminal at least indicating an address of the target network gateway, and by sending the obtained session data to the signaling node arrangement for establishing the new communication path via the target network gateway node.

Alternatively, the redirect of the new communication path may be performed by the actions of: forwarding the received establishing message to the target network node based on the redirecting information, and by sending from the target network node to the signaling node arrangement, session data for the radio terminal at least indicating an address of the target network gateway for establishing the new communication path via the target network gateway node.

Alternatively, the redirect of the new communication path may be performed by the actions of: sending the redirecting information to the signaling node arrangement, so as to enable the signaling node arrangement to establish the new communication path (184) via the target network gateway node (110a).

The redirect of the new communication path may be performed by the actions of establishing in the signaling node arrangement the new communication path via the target network gateway node based on the received session data or the received redirecting information.

The storing function may be an Authentication, Authorization and Accounting, AAA, arrangement, or a Home Subscriber Server, HSS, or a separate RADIUS server.

The signaling node arrangement may be a serving GPRS support node, SGSN, or a mobility management entity, MME, or a serving gateway, SGW, or a trusted WLAN access network, TWAN.

A communication path may be established between the radio terminal and the peer node via the source network gateway if there is no existing communication path for the radio terminal via a target network gateway node, and redirecting information indicating at least one of; an identity of or an address to the source network gateway node may be stored in a storing function so as to make the source network node a target network gateway node.

The establishing message may be received from the signaling node arrangement according to a GPRS Tunnel Protocol, GTP, signaling scheme, or a Proxy Mobile IP, PMIP, signaling scheme. The received establishing message is a create session request message or a proxy binding update message.

Some other embodiments described above may be summarized in the following manner:

One other embodiment is directed to a source network gateway node configured to operatively redirect a communication path between a peer node and a radio terminal that supports multipath communication with the peer node so as to enable a plurality of communication paths between the radio terminal and the peer node.

The source gateway node comprises: an interfacing arrangement configured to operatively receive an establishing message from a signaling node arrangement signaling the establishment of a new communication path between the radio terminal and the peer node via the source network gateway node, and a processing arrangement configured to operatively determine whether there already is an existing communication path for the radio terminal via a target network gateway node, and to operatively initiate a redirect of the new communication path if there is an existing communication path such that the redirected new communication path is established via the target network gateway node.

The determining may be performed by the processing arrangement being configured to operatively obtain redirecting information at least indicating one of; an identity of or an address to the target network gateway node, from a storing function comprising such redirecting information.

The new communication path may be redirected by: the processing arrangement being configured to operatively obtain, from the target network gateway based on the redirecting information, session data for the radio terminal at least indicating an address of the target network gateway, and the interfacing arrangement being configured to operatively send the obtained session data to the signaling node arrangement for establishing the new communication path via the target network gateway node.

Alternatively, the new communication path may be redirected by: the interfacing arrangement being configured to operatively forward the received establishing message to the target network node based on the redirecting information, so as to enable the target network node to send to the signaling node arrangement, session data for the radio terminal at least indicating an address of the target network gateway for establishing the new communication path via the target network gateway node.

Alternatively, the new communication path may be redirected by: the interfacing arrangement being configured to operatively send the redirecting information to the signaling node arrangement, so as to enable the signaling node arrangement to establish the new communication path via the target network gateway node.

The storing function may be an Authentication, Authorization and Accounting, AAA, arrangement, or a Home Subscriber Server, HSS or a separate RADIUS server.

The signaling node arrangement may be a serving GPRS support node, SGSN, or a mobility management entity, MME, or a serving gateway, SGW, or a trusted WLAN access network, TWAN.

The processing arrangement may be configured to establish a communication path between the radio terminal and the peer via the source network gateway if there is no existing communication path for the radio terminal via a target network gateway node, and to store redirecting information indicating at least one of an identity of or an address to the source network gateway node in a storing function and thus making the source network node a target network gateway node.

The interfacing arrangement may be configured to operatively receive the establishing message from the signaling node arrangement according to a GPRS Tunnel Protocol, GTP, signaling scheme, or a Proxy Mobile IP, PMIP, signaling scheme. The received establishing message may be a create session request message or a proxy binding update message.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps or actions than those listed and the words “a” or “an” preceding an element do not exclude the presence of a plurality of such elements. It should further be noted that any reference signs do not limit the scope of the example embodiments, that the example embodiments may be implemented at least in part by means of both hardware and software, and that several “means”, “units” or “devices” may be represented by the same item of hardware.

### ABBREVIATIONS

S1-MME: Reference point for the control plane protocol between E-UTRAN and MME.

S1-U: Reference point between E-UTRAN and Serving GW for the per bearer user plane tunnelling and inter eNodeB path switching during handover.

S3: It enables user and bearer information exchange for inter 3GPP access network mobility in idle and/or active state.

S4: It provides related control and mobility support between GPRS Core and the 3GPP Anchor function of Serving GW. In addition, if Direct Tunnel is not established, it provides the user plane tunnelling.

S5: It provides user plane tunnelling and tunnel management between Serving GW and PDN GW. It is used for Serving GW relocation due to UE mobility and if the Serving GW needs to connect to a non-collocated PDN GW for the required PDN connectivity.

S6a: It enables transfer of subscription and authentication data for authenticating/authorizing user access to the evolved system (AAA interface) between MME and HSS.

Gx: It provides transfer of (QoS) policy and charging rules from PCRF to Policy and Charging Enforcement Function (PCEF) in the PDN GW.

S8: Inter-PLMN reference point providing user and control plane between the Serving GW in the VPLMN and the PDN GW in the HPLMN. S8 is the inter PLMN variant of S5.

S9: It provides transfer of (QoS) policy and charging control information between the Home PCRF and the Visited PCRF in order to support local breakout function.

S10: Reference point between MMEs for MME relocation and MME to MME information transfer.

S11: Reference point between MME and Serving GW.

S12: Reference point between UTRAN and Serving GW for user plane tunnelling when Direct Tunnel is established. It is based on the Iu-u/Gn-u reference point using the GTP-U protocol as defined between SGSN and UTRAN or respectively between SGSN and GGSN. Usage of S12 is an operator configuration option.

S13: It enables UE identity check procedure between MME and EIR.

SGi: It is the reference point between the PDN GW and the packet data network. Packet data network may be an operator external public or private packet data network or an intra operator packet data network, e.g. for provision of IMS services. This reference point corresponds to Gi for 3GPP accesses.

Rx: The Rx reference point resides between the AF and the PCRF in the TS 23.203 [6].

AAA Authentication, Authorization and Accounting

AF Application Function

AN Access Network

ARP Allocation and Retention Priority

AMBR Aggregate Maximum Bit Rate

ANDSF Access Network Discovery and Selection Function

BBERF Bearer Binding and Event Reporting Function

BSC Base Station Controller

BSS Base Station System

BSSGP Base Station System GPRS Protocol

BTS Base Station

CBC Cell Broadcast Centre

CBE Cell Broadcast Entity

CCoA Collocated Care-of-address

CN Core Network

CSG Closed Subscriber Group

CSG ID Closed Subscriber Group Identity

DL TFT DownLink Traffic Flow Template

DSMIPv6 Dual-Stack MIPv6

eAN enhanced AN

ECGI E-UTRAN Cell Global Identifier

ECM EPS Connection Management

ECN Explicit Congestion Notification

eGTP enhanced Gateway Tunnelling Protocol

eNodeB enhanced Node B

EMM EPS Mobility Management

EPC Evolved Packet Core

EPS Evolved Packet System

ePDG Evolved Packet Data Gateway

E-RAB E-UTRAN Radio Access Bearer

E-UTRAN Evolved Universal Terrestrial Radio Access Network

FACoA Foreign Agent Care-of-Address

FQDN Fully Qualified Domain Name

F-TEID Fully Qualified Tunnel End Point Identifier

GBR Guaranteed Bit Rate

GERAN GSM Edge Radio Access Network

GGSN Gateway GPRS Support Node

GPRS General Packet Radio Service

GRE Generic Routing Encapsulation

GSM Global Communications System

GTP GPRS Tunneling Protocol

GTP-C GTP control

GTP-U GTP user data tunneling

GUMMEI Globally Unique MME Identifier

GUTI Globally Unique Temporary Identity

GW Gateway

H ANDSF Home-ANDSF

HeNB Home eNode B

HeNB GW Home eNode B Gateway

HFN Hyper Frame Number

HO HandOver

HRPD High Rate Packet Data

HSGW HRPD Serving GateWay

HSS Home Subscriber Server

IE Information Element

IETF Internet Engineering Task Force

IMSI International Mobile Station Identity

IFOM IP Flow Mobility

IP Internet Protocol

IPMS IP Mobility management Selection

ISR Idle mode Signalling Reduction

LBI Linked EPS Bearer Id

L-GW Local GateWay

LTA Local IP Access

LMA Local Mobility Anchor

LTE Long Term Evolution

MAG Mobile Access Gateway

MAPCON Multi Access PDN Connectivity

MBR Maximum Bit Rate

MIB Minimum Bit Rate

MIPv4 Mobile IP version 4

MIPv6 Mobile IP version 6

MME Mobility Management Entity

MMEC MME Code

MSC Mobile Switching Center

MTC Machine-Type Communications

M-TMSI M-Temporary Mobile Subscriber Identity

OFCS Offline Charging System

OMC-ID Operation and Maintenance Centre Identity

PCC Policy Control and Charging

PCF Packet Control Function

PCEF Policy and Charging Enforcement Function

PCRF Policy and Charging Rules Function

PDN Packet data Network

PDP Packet Data Protocol

PGW PDN Gateway

PDCP Packet Data Convergence Protocol

PLMN Public Land Mobile Network

PMIP Proxy Mobile IP

PMIPv6 Proxy Mobile IP version 6

PSAP Public Safety Answering Point

PTI Procedure Transaction Id

QCI QoS Class Identifier

QoS Quality of Service

OCS Online Charging Systems

QSUP QoS based on Service information in User Plane protocol

RADUIS Remote Authentication Dial In User Service

RAN Radio Access Network

RFSP RAT/Frequency Selection Priority

RNAP Radio Access Network Application Part RNC Radio Network Controller

SACC Service Aware Charging and Control

SGSN Serving GPRS Support Node

SGW Serving Gateway

SectorID Sector Address Identifier

S-TMSI S-Temporary Mobile Subscriber Identity

SDF Service Data Flow

SI Service Identification

SIPTO Selected IP Traffic Offload

TAC Tracking Area Code

TAD Traffic Aggregate Description

TAI Tracking Area Identity

TAU Tracking Area Update

TDF Traffic Detection Function

TEID Tunnel End Point Identifier

TI Transaction Identifier

TIN Temporary Identity used in Next update

TDF Traffic Detection Function

UE User Equipment

UDP User Datagram Protocol

UMTS Universal Mobile Telecommunications System

URRP-MME UE Reachability Request Parameter for MME UTRAN UMTS Terrestria Radio Access Network

UL TFT UpLink Traffic Flow Template

ULR-Flags Update Location Request Flags

VLR Visitor Location Register

V ANDSF Visited-ANDSF

VS Vendor Specific

WLAN Wireless Local Area Network

1. A method in a source network gateway node for redirecting a communication path between a peer node and a radio terminal that supports multipath communication with the peer node so as to enable a plurality of communication paths between the radio terminal and the peer node, wherein the method comprises the actions of:
receiving an establishing message from a signaling node arrangement signaling the establishment of a new communication path between the radio terminal and the peer node via the source network gateway node,
determining whether there already is an existing communication path between the radio terminal and the peer node via a target network gateway node, and
initiating a redirect of the new communication path if there is an existing communication path such that the new communication path is established via the target network gateway node.

2. The method according to claim 1, wherein the determining is done by obtaining redirecting information at least indicating one of: an identity of or an address to the target network gateway node, from a storing function comprising such redirecting information.

3. The method according to claim 2, wherein the redirect of the new communication path is performed by the actions of:
obtaining, from the target network gateway based on the redirecting information, session data for the radio terminal at least indicating an address of the target network gateway, and
sending the obtained session data to the signaling node arrangement for establishing the new communication path via the target network gateway node.

4. The method according to claim 2, wherein the redirect of the new communication path is performed by the actions of:
forwarding the received establishing message to the target network node based on the redirecting information, and
sending from the target network node to the signaling node arrangement, session data for the radio terminal at least indicating an address of the target network gateway for establishing the new communication path via the target network gateway node.

5. The method according to claim 2, wherein the redirect of the new communication path is performed by the actions of:
sending the redirecting information to the signaling node arrangement, so as to enable the signaling node arrangement to establish the new communication path via the target network gateway node.

6. The method according to claim 3, wherein the redirect of the new communication path is performed by the actions of:
establishing in the signaling node arrangement the new communication path via the target network gateway node based on the received session data or the received redirecting information.

7. The method according to claim 2, wherein the storing function is an Authentication, Authorization and Accounting, AAA, arrangement, or a Home Subscriber Server, HSS or a separate RADIUS server.

8. The method according to claim 1, wherein the signaling node arrangement is a serving GPRS support node, SGSN, or a mobility management entity, MME, or a serving gateway, SGW, or a trusted WLAN access network, TWAN.

9. The method in claim 1, further comprising the actions of:
establishing a communication path between the radio terminal and the peer via the source network gateway if there is no existing communication path for the radio terminal via a target network gateway node, and
storing redirecting information indicating at least one of an identity of or an address to the source network gateway node in a storing function and thus making the source network node a target network gateway node.

10. The method according to claim 1, wherein the establishing message is received from the signaling node arrangement according to a GPRS Tunnel Protocol, GTP, signaling scheme, or a Proxy Mobile IP, PMIP, signaling scheme.

11. The method of claim 10, wherein the received establishing message is a create session request message or a proxy binding update message.

12. A source network gateway node configured to operatively redirect a communication path between a peer node and a radio terminal that supports multipath communication with the peer node so as to enable a plurality of communication paths between the radio terminal and the peer node, wherein the source gateway node comprises:
an interfacing apparatus configured to operatively receive an establishing message from a signaling node arrangement signaling the establishment of a new communication path between the radio terminal and the peer node via the source network gateway node, and
a processing apparatus configured to operatively determine whether there already is an existing communication path between the radio terminal and the peer node via a target network gateway node, and to operatively initiate a redirect of the new communication path if there is an existing communication path such that the new communication path is established via the target network gateway node.

13. The source network gateway node according to claim 12, wherein said determining is performed by the processing apparatus being configured to operatively obtain redirecting information at least indicating one of; an identity of or an address to the target network gateway node, from a storing function comprising such redirecting information.

14. The source network gateway node according to claim 13, wherein the new communication path is redirected by:
the processing apparatus being configured to operatively obtain (13a, 14a; 13b, 14b), from the target network gateway based on the redirecting information, session data for the radio terminal at least indicating an address of the target network gateway, and
the interfacing apparatus being configured to operatively send the obtained session data to the signaling node arrangement for establishing the new communication path via the target network gateway node.

15. The source network gateway node according to claim 13, wherein the new communication path is redirected by:
the interfacing apparatus being configured to operatively forward (13a′, 12b′) the received establishing message to the target network node based on the redirecting information, so as to enable the target network node to send (14a′, 13b′) to the signaling node arrangement, session data for the radio terminal at least indicating an address of the target network gateway for establishing the new communication path via the target network gateway node.

16-22. (canceled)

23. The source network gateway node according to claim 13, wherein the new communication path is redirected by: the interfacing apparatus being configured to operatively send the redirecting information to the signaling node arrangement, so as to enable the signaling node arrangement to establish the new communication path via the target network gateway node.

24. The source network gateway node according to claim 13, wherein the storing function is an Authentication, Authorization and Accounting, AAA, arrangement, or a Home Subscriber Server, HSS or a separate RADIUS server.

25. The source network gateway node according to claim 13, wherein the signaling node arrangement is a serving GPRS support node, SGSN, or a mobility management entity, MME, or a serving gateway, SGW, or a trusted WLAN access network, TWAN.

26. The source network gateway node according to claim 13, wherein: the processing apparatus is configured to establish a communication path between the radio terminal and the peer via the source network gateway if there is no existing communication path for the radio terminal via a target network gateway node, and to store redirecting information indicating at least one of; an identity of or an address to the source network gateway node in a storing function and thus making the source network node a target network gateway node.

27. The source network gateway node according to claim 13, wherein: the interfacing apparatus is configured to operatively receive the establishing message is received from the signaling node arrangement according to a GPRS Tunnel Protocol, GTP, signaling scheme, or a Proxy Mobile IP, PMIP, signaling scheme.

28. The source network gateway node according to claim 27, wherein: the received establishing message is a create session request message or a proxy binding update message.
